(19) United States
(12) Patent Application Publication
(10) Pub. No.: US 2026/0134839 A1
(43) Pub. Date: May 14, 2026

(54) DISPLAY DEVICE AND ELECTRONIC DEVICE INCLUDING THE SAME

(71) Applicant: Samsung Display Co., Ltd., Yongin-si, Gyeonggi-do (KR)

(72) Inventors: Hyang A PARK, Yongin-si (KR); Bo Kwang SONG, Yongin-si (KR); Seo Young LIM, Yongin-si (KR); Soo Yeong HONG, Yongin-si (KR)

(21) Appl. No.: 19/234,094

(22) Filed: Jun. 10, 2025

(30) Foreign Application Priority Data
Nov. 8, 2024 (KR) 10-2024-0158188

(51) Int. Cl. G09G 3/3266; G09G 3/32

(52) U.S. Cl. CPC G09G 3/3266; G09G 3/32; G09G 2300/0426; G09G 2300/0819; G09G 2310/0267; G09G 2340/0457; G09G 2360/148

(57) ABSTRACT

A display device includes a substrate, a circuit layer, and an element layer. A display area of the substrate includes emission areas arranged side by side and configured to emit light, and a non-emission area between the emission areas. A display sensing area, which is at least a part of the display area, includes light sensing areas arranged in the non-emission area. The element layer includes light emitting elements in the emission areas, and light sensing elements in the light sensing areas. The circuit layer includes an additional conductive layer on the substrate; an additional buffer layer covering the additional conductive layer; a light blocking conductive layer on the additional buffer layer; a buffer layer covering the light blocking conductive layer; and a first semiconductor layer on the buffer layer.

### CROSS-REFERENCE TO RELATED APPLICATION

This application claims priority to and the benefit of Korean Patent Application No. 10-2024-0158188, filed on Nov. 8, 2024, in the Korean Intellectual Property Office, the entire disclosure of which is incorporated by reference herein.

### BACKGROUND

### 1. Field

The present disclosure relates to a display device and an electronic device including the same.

### 2. Description of the Related Art

With the advance of information-oriented society, more and more demands are placed on display devices for displaying images in various ways. For example, display devices are employed in various electronic devices such as smartphones, digital cameras, laptop computers, navigation devices, and/or smart televisions.

The display device may be a flat panel display device such as a liquid crystal display device, a field emission display device and a light emitting display device. Examples of the light emitting display device may include an organic light emitting display device including organic light emitting elements, an inorganic light emitting display device including inorganic light emitting elements such as inorganic semiconductors, and a micro light emitting display device including micro light emitting elements.

The organic light emitting display device displays an image using light emitting elements, each including a light emitting layer made of an organic light emitting material. As described above, the organic light emitting display device implements image display using a self-light emitting element, and thus may have relatively superior performance in power consumption, response speed, luminous efficiency, luminance, and wide viewing angle compared to other display devices.

One surface of the display device may be a display surface including a display area in which an image is displayed and a non-display area that is a periphery of the display area. Emission areas emitting light with respective luminances and colors may be arranged in the display area.

### SUMMARY

The display device may additionally provide various input functions as well as a function of displaying an image in order to be applied to various electronic devices.

For example, the display device may provide a scanning function for detecting a curvature of an object in contact with a screen based on differences in the amount of light reflected from the screen. In this case, the display device may include light sensing elements that sense the amount of light, light sensing pixel drivers electrically connected to the light sensing elements, a scanning driving circuit that collects light sensing signals by the light sensing elements, and read-out lines electrically connected between the light sensing pixel drivers and the scanning driving circuit.

However, the light sensing signals transmitted through the read-out lines may be coupled with data signals transmitted to the light emitting pixel drivers through data lines, and thus may be easily distorted. Therefore, the precision of a scanning function may deteriorate.

Alternatively, in order to reduce coupling failure of the light sensing signals, the read-out lines may be spaced (e.g., spaced apart) from the data line by a critical gap or more. Therefore, it may be difficult to improve the resolution of the display device.

In view of the foregoing, one or more embodiments of the present disclosure provides a display device capable of improving the resolution while preventing deterioration of the precision of the scanning function, and an electronic device including the same.

However, aspects and features of the embodiments of the present disclosure are not restricted to the one set forth herein. The above and other aspects and features of the embodiments of the present disclosure will become more apparent to one of ordinary skill in the art to which the present disclosure pertains by referencing the detailed description of the present disclosure given below.

According to one or more embodiments of the present disclosure, there is provided a display device including a substrate having a display area from which light is emitted, and a non-display area around the display area; a circuit layer on the substrate; and an element layer on the circuit layer. The display area includes emission areas arranged side by side and emitting light, and a non-emission area between the emission areas. A display sensing area, which is at least a part of the display area, the display sensing area including light sensing areas arranged in the non-emission area. The element layer includes light emitting elements in the emission areas, and light sensing elements in the light sensing areas. The circuit layer includes an additional conductive layer on the substrate; an additional buffer layer covering the additional conductive layer; a light blocking conductive layer on the additional buffer layer; a buffer layer covering the light blocking conductive layer; and a first semiconductor layer on the buffer layer.

The display device further includes a scanning driving circuit configured to collect light sensing signals by the light sensing elements. The circuit layer further includes light sensing pixel drivers electrically connected to the light sensing elements; and read-out lines electrically connected between the light sensing pixel drivers and the scanning driving circuit. The read-out lines are in the light blocking conductive layer.

The circuit layer further includes light emitting pixel drivers electrically connected to the light emitting elements; and data lines electrically connected to the light emitting pixel drivers.

The circuit layer further includes a first gate insulating layer covering the first semiconductor layer; a first gate conductive layer on the first gate insulating layer; a second gate insulating layer covering the first gate conductive layer; a second gate conductive layer on the second gate insulating layer; a first interlayer insulating layer covering the second gate conductive layer; a second semiconductor layer on the first interlayer insulating layer; a third gate insulating layer covering the second semiconductor layer; a third gate conductive layer on the third gate insulating layer; a second interlayer insulating layer covering the third gate conductive layer; a first source-drain conductive layer on the second interlayer insulating layer; a first planarization layer covering the first source-drain conductive layer; a second source-drain conductive layer on the first planarization layer; a second planarization layer covering the second source-drain conductive layer; a third source-drain conductive layer on the second planarization layer; and a third planarization layer covering the third source-drain conductive layer. The data lines are in the third source-drain conductive layer.

The display sensing area is in the entire display area.

Each of the light sensing pixel drivers includes at least one first sensing transistor electrically connected between an output node and at least one of the light sensing elements; a second sensing transistor electrically connected between the output node and a reset voltage line configured to transmit a reset voltage; a third sensing transistor electrically connected to a sensing initialization voltage line configured to transmit a sensing initialization voltage, the third sensing transistor being turned on according to a potential of the output node; and a fourth sensing transistor electrically connected between a read-out line from among the read-out lines and the third sensing transistor.

Each of the first sensing transistor, the second sensing transistor, the third sensing transistor, and the fourth sensing transistor includes a gate electrode, a channel portion overlapping the gate electrode, a first electrode portion connected to one side of the channel portion, and a second electrode portion connected to the other side of the channel portion. The channel portion, the first electrode portion and the second electrode portion of each of the third sensing transistor and the fourth sensing transistor are in the first semiconductor layer. The gate electrode of each of the third sensing transistor and the fourth sensing transistor is in the first gate conductive layer. The first electrode portion of the third sensing transistor is electrically connected to the sensing initialization voltage line. The first electrode portion of the fourth sensing transistor is connected between the first electrode portion of the third sensing transistor and one side of the channel portion of the fourth sensing transistor. The second electrode portion of the fourth sensing transistor is electrically connected to the read-out line.

The circuit layer further includes a read-out connection electrode in the third gate conductive layer and electrically connected to the read-out line and the second electrode portion of the fourth sensing transistor.

The channel portion, the first electrode portion and the second electrode portion of each of the at least one first sensing transistor and the second sensing transistor are in the second semiconductor layer. The gate electrode of each of the at least one first sensing transistor and the second sensing transistor is in the third gate conductive layer.

The display device further includes a display driving circuit configured to supply data signals of the data lines. The circuit layer further includes data supply lines in the non-display area and electrically connected between each of the data lines and the display driving circuit; and a first power supply line in the non-display area and configured to transmit a first power. The read-out lines extend to the non-display area. Each of the data supply lines is in one of the first gate conductive layer and the second gate conductive layer. The first power supply line is in the light blocking conductive layer. A part of the first power supply line overlaps the data supply lines and the read-out lines.

In the display area, a bypass area includes a bypass middle area, a first bypass side area parallel to the bypass middle area in a first direction and in contact with the non-display area, and a second bypass side area between the bypass middle area and the first bypass side area. The data supply lines extend to the bypass middle area and the second bypass side area. The data lines include a first data line in the first bypass side area, and a second data line in the second bypass side area. The circuit layer further includes first auxiliary lines in the display area and extending in the first direction; and second auxiliary lines in the display area and extending in a second direction intersecting the first direction and adjacent to the data lines. The first auxiliary lines include a first bypass auxiliary line in at least one of the first source-drain conductive layer or the second source-drain conductive layer and electrically connected to the first data line. The second auxiliary lines include a second bypass auxiliary line in the third source-drain conductive layer, adjacent to the second data line and electrically connected to the first bypass auxiliary line. The data supply lines include a first data supply line transmitting a data signal of the first data line, and a second data supply line transmitting a data signal of the second data line. The first data supply line is electrically connected to the first data line through the second bypass auxiliary line and the first bypass auxiliary line. The second data supply line is electrically connected directly to the second data line.

Each of the light emitting pixel drivers includes a first transistor electrically connected between a first node and a second node; a second transistor electrically connected between the first node and one of the data lines; a pixel capacitor electrically connected between a first power line configured to transmit the first power and a gate electrode of the first transistor; a third transistor electrically connected between the second node and the gate electrode of the first transistor; a fourth transistor electrically connected between a first initialization voltage line configured to transmit a first initialization voltage and the gate electrode of the first transistor; a fifth transistor electrically connected between the first power line and the first node; a sixth transistor electrically connected between a third node and the second node; a seventh transistor electrically connected between the third node and a second initialization voltage line configured to transmit a second initialization voltage; and an eighth transistor electrically connected between the first node and a bias voltage line configured to transmit a bias voltage.

Each of the first transistor, the second transistor, the third transistor, the fourth transistor, the fifth transistor, the sixth transistor, the seventh transistor and the eighth transistor includes a gate electrode, a channel portion overlapping the gate electrode, a first electrode portion connected to one side of the channel portion, and a second electrode portion connected to the other side of the channel portion. The channel portion, the first electrode portion and the second electrode portion of each of the first transistor, the second transistor, the fifth transistor, the sixth transistor, the seventh transistor and the eighth transistor are in the first semiconductor layer. The gate electrode of each of the first transistor, the second transistor, the fifth transistor, the sixth transistor, the seventh transistor and the eighth transistor is in the first gate conductive layer. The channel portion, the first electrode portion, and the second electrode portion of each of the third transistor and the fourth transistor are in the second semiconductor layer. The gate electrode of each of the third transistor and the fourth transistor is in the third gate conductive layer. The light blocking conductive layer includes a light blocking portion overlapping the channel portion of the first transistor.

The circuit layer further includes a power auxiliary line in the light blocking conductive layer, connected to the light blocking portion, and configured to transmit the first power.

According to one or more embodiments of the present disclosure, there is provided an electronic device including a display device configured to display an image; a memory configured to store an application; a processor configured to execute the application and configured to transmit an image data signal and an input control signal to the display device; and a power supply module configured to supply power to the display device. The display device includes a substrate having a display area from which light is emitted, and a non-display area around the display area; a circuit layer on the substrate; and an element layer on the circuit layer. The display area includes emission areas arranged side by side and configured to emit light, and a non-emission area between the emission areas. A display sensing area, which is at least a part of the display area, includes light sensing areas arranged in the non-emission area. The element layer includes light emitting elements in the emission areas, and light sensing elements in the light sensing areas. The circuit layer includes an additional conductive layer on the substrate; an additional buffer layer covering the additional conductive layer; a light blocking conductive layer on the additional buffer layer; a buffer layer covering the light blocking conductive layer; a first semiconductor layer on the buffer layer; a first gate insulating layer covering the first semiconductor layer; a first gate conductive layer on the first gate insulating layer; a second gate insulating layer covering the first gate conductive layer; a second gate conductive layer on the second gate insulating layer; a first interlayer insulating layer covering the second gate conductive layer; a second semiconductor layer on the first interlayer insulating layer; a third gate insulating layer covering the second semiconductor layer; a third gate conductive layer on the third gate insulating layer; a second interlayer insulating layer covering the third gate conductive layer; a first source-drain conductive layer on the second interlayer insulating layer; a first planarization layer covering the first source-drain conductive layer; a second source-drain conductive layer on the first planarization layer; a second planarization layer covering the second source-drain conductive layer; a third source-drain conductive layer on the second planarization layer; and a third planarization layer covering the third source-drain conductive layer.

The electronic device further includes a display driving circuit configured to supply data signals; and a scanning driving circuit configured to collect light sensing signals of the light sensing elements. The circuit layer further includes light sensing pixel drivers electrically connected to the light sensing elements; read-out lines electrically connected between the light sensing pixel drivers and the scanning driving circuit; light emitting pixel drivers electrically connected to the light emitting elements; and data lines electrically connected between the light emitting pixel drivers and the display driving circuit. The read-out lines are in the light blocking conductive layer. The data lines are in the third source-drain conductive layer.

The display sensing area is in the entire display area.

Each of the light sensing pixel drivers includes at least one first sensing transistor electrically connected between an output node and at least one of the light sensing elements; a second sensing transistor electrically connected between the output node and a reset voltage line configured to transmit a reset voltage; a third sensing transistor electrically connected to a sensing initialization voltage line configured to transmit a sensing initialization voltage, the third sensing transistor being turned on according to a potential of the output node; and a fourth sensing transistor electrically connected between one of the read-out lines and the third sensing transistor. Each of the first sensing transistor, the second sensing transistor, the third sensing transistor and the fourth sensing transistor includes a gate electrode, a channel portion overlapping the gate electrode, a first electrode portion connected to one side of the channel portion, and a second electrode portion connected to the other side of the channel portion. The channel portion, the first electrode portion and the second electrode portion of each of the third sensing transistor and the fourth sensing transistor are in the first semiconductor layer. The second electrode portion of the fourth sensing transistor is electrically connected to the read-out line through a read-out connection electrode. The read-out connection electrode is in the third gate conductive layer.

The electronic device further includes a display driving circuit configured to supply data signals of the data lines. The circuit layer further includes data supply lines in the non-display area and electrically connected between each of the data lines and the display driving circuit; and a first power supply line in the non-display area and configured to transmit a first power. The read-out lines extend to the non-display area. Each of the data supply lines is in one of the first gate conductive layer and the second gate conductive layer. The first power supply line is in the light blocking conductive layer. A part of the first power supply line overlaps the data supply lines and the read-out lines.

Each of the light emitting pixel drivers includes a first transistor electrically connected between a first node and a second node; a second transistor electrically connected between the first node and one of the data lines; a pixel capacitor electrically connected between a first power line configured to transmit the first power and a gate electrode of the first transistor; a third transistor electrically connected between the second node and the gate electrode of the first transistor; a fourth transistor electrically connected between a first initialization voltage line transmitting a first initialization voltage and the gate electrode of the first transistor; a fifth transistor electrically connected between the first power line and the first node; a sixth transistor electrically connected between a third node and the second node; a seventh transistor electrically connected between the third node and a second initialization voltage line configured to transmit a second initialization voltage; and an eighth transistor electrically connected between the first node and a bias voltage line configured to transmit a bias voltage. Each of the first transistor, the second transistor, the third transistor, the fourth transistor, the fifth transistor, the sixth transistor, the seventh transistor and the eighth transistor includes a gate electrode, a channel portion overlapping the gate electrode, a first electrode portion connected to one side of the channel portion, and a second electrode portion connected to the other side of the channel portion. The channel portion, the first electrode portion and the second electrode portion of each of the first transistor, the second transistor, the fifth transistor, the sixth transistor, the seventh transistor and the eighth transistor are in the first semiconductor layer. The channel portion, the first electrode portion, and the second electrode portion of each of the third transistor and the fourth transistor are in the second semiconductor layer. The light blocking conductive layer includes a light blocking portion overlapping the channel portion of the first transistor; and a power auxiliary line connected to the light blocking portion and configured to transmit the first power.

The display device according to one or more embodiments includes a substrate, a circuit layer on the substrate, and an element layer on the circuit layer. The display area of the substrate may include emission areas arranged side by side, and a non-emission area between the emission areas. A display sensing area, which is at least a part of the display area, may include light sensing areas arranged in the non-emission area.

The element layer may include light emitting elements in the emission areas, and light sensing elements in the light sensing areas.

The circuit layer may include an additional conductive layer on the substrate, an additional buffer layer covering the additional conductive layer, a light blocking conductive layer on the additional buffer layer, a buffer layer covering the light blocking conductive layer, and a first semiconductor layer on the buffer layer.

The circuit layer may further include a first gate insulating layer covering the first semiconductor layer, a first gate conductive layer on the first gate insulating layer, a second gate insulating layer covering the first gate conductive layer, a second gate conductive layer on the second gate insulating layer, a first interlayer insulating layer covering the second gate conductive layer, a second semiconductor layer on the first interlayer insulating layer, a third gate insulating layer covering the second semiconductor layer, a third gate conductive layer on the third gate insulating layer, a second interlayer insulating layer covering the third gate conductive layer, a first source-drain conductive layer on the second interlayer insulating layer, a first planarization layer covering the first source-drain conductive layer, a second source-drain conductive layer on the first planarization layer, a second planarization layer covering the second source-drain conductive layer, a third source-drain conductive layer on the second planarization layer, and a third planarization layer covering the third source-drain conductive layer.

According to one or more embodiments, the circuit layer may include light sensing pixel drivers electrically connected to the light sensing elements, read-out lines electrically connected between the light sensing pixel drivers and the scanning driving circuit, light emitting pixel drivers electrically connected to the light emitting elements, and data lines electrically connected to the light emitting pixel drivers.

According to one or more embodiments, the read-out lines may be in the additional conductive layer, and the data lines may be in the third source-drain conductive layer.

In this way, an additional insulating layer, a first gate insulating layer, a second gate insulating layer, a first interlayer insulating layer, a third gate insulating layer, a second interlayer insulating layer, a first planarization layer, and a second planarization layer are interposed between the read-out lines and the data lines, so that the separation distance between the read-out lines and the data lines may be easily secured in the thickness direction of the substrate.

That is, even if the separation distance between the read-out lines and the data lines, which is greater than or equal to a critical value, is not secured in a coordinate system including a first direction intersecting the data lines and a second direction in which the data lines extend, a defect in which light sensing signals transmitted through the read-out lines are distorted by data signals transmitted through the data lines may be reduced.

In other words, even if the separation distance between the read-out lines and the data lines in the coordinate system of the first direction and the second direction is reduced, the light sensing signals may be protected from coupling distortion with the data signals. Therefore, the resolution may be improved while preventing the deterioration of the precision of the scanning function.

It should be noted that effects, aspects, and features of the present disclosure are not limited to those described above and other effects, aspects, and features of the present disclosure will be apparent to those skilled in the art from the following descriptions.

### BRIEF DESCRIPTION OF THE DRAWINGS

The above and other aspects and features of the present disclosure will become more apparent by describing in detail embodiments thereof with reference to the attached drawings, in which:

FIG. 1 is a perspective view showing an electronic device according to one or more embodiments;

FIG. 2 is an exploded perspective view of the electronic device shown in FIG. 1;

FIG. 3 is a plan view illustrating the display device of FIG. 2;

FIG. 4 is a cross-sectional view taken along the line A-A′ of FIG. 3;

FIG. 5 is a schematic diagram illustrating the substrate of FIG. 4 according to one or more embodiments;

FIG. 6 is a schematic diagram showing a part B of FIG. 5;

FIG. 7 is a schematic diagram showing a part C of FIG. 5;

FIG. 8 is a schematic diagram showing a scanning function by light sensing elements disposed in the light sensing areas of FIG. 7;

FIG. 9 is a block diagram showing the circuit layer of FIG. 4;

FIG. 10 is an equivalent circuit diagram of the light emitting pixel driver and the light sensing pixel driver shown in FIG. 9;

FIG. 11 is a plan view showing transistors in two adjacent light emitting pixel drivers shown in FIGS. 6 and 7;

FIG. 12 is a cross-sectional view showing the first transistor, the second transistor, the fourth transistor, the sixth transistor, and the light emitting element shown in FIG. 10;

FIG. 13 is a schematic diagram illustrating the substrate of FIG. 4 according to one or more embodiments;

FIG. 14 is a schematic diagram showing a part D of FIG. 13 according to one or more embodiments;

FIG. 15 is a cross-sectional view taken along the line E-E′ of FIG. 14;

FIG. 16 is a cross-sectional view taken along the line F-F′ of FIG. 14;

FIG. 17 is a plan view showing a part G of FIG. 14;

FIG. 18 is a cross-sectional view taken along the line H-H′ of FIG. 17;

FIG. 19 is a schematic diagram illustrating the substrate of FIG. 4 according to one or more embodiments;

FIG. 20 is a schematic diagram showing a part B′ of FIG. 19;

FIG. 21 is a schematic diagram showing a part D of FIG. 13 according to one embodiment; and

FIG. 22 is a cross-sectional view taken along the line I-I′ of FIG. 21.

FIG. 23 is a block diagram showing an electronic device according to one or more embodiments; and

FIG. 24 is a schematic diagram of electronic devices according to one or more embodiments.

### DETAILED DESCRIPTION

The embodiments will now be described more fully hereinafter with reference to the accompanying drawings. The embodiments may, however, be provided in different forms and should not be construed as limiting. The same reference numbers indicate the same components throughout the present disclosure. In the accompanying figures, the thickness of layers and regions may be exaggerated for clarity.

Some of the parts which are not associated with the description may not be provided in order to describe embodiments of the present disclosure.

It will also be understood that when a layer is referred to as being “on” another layer or substrate, it can be directly on the other layer or substrate, or intervening layers may also be present. In contrast, when an element is referred to as being “directly on” another element, there may be no intervening elements present.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

The spatially relative terms “below,” “beneath,” “lower,” “above,” “upper,” and/or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

When an element is referred to as being “connected” or “coupled” to another element, the element may be “directly connected” or “directly coupled” to another element, or “electrically connected” or “electrically coupled” to another element with one or more intervening elements interposed therebetween. It will be further understood that when the terms “comprises,” “comprising,” “has,” “have,” “having,” “includes” and/or “including” are used, they may specify the presence of stated features, integers, steps, operations, elements and/or components, but do not preclude the presence or addition of other features, integers, steps, operations, elements, components, and/or any combination thereof.

It will be understood that, although the terms “first,” “second,” “third,” and/or the like may be used herein to describe various elements, these elements should not be limited by these terms. These terms are used to distinguish one element from another element or for the convenience of description and explanation thereof. For example, when “a first element” is discussed in the description, it may be termed “a second element” or “a third element,” and “a second element” and “a third element” may be termed in a similar manner without departing from the teachings herein.

The terms “about” or “approximately” as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, “about” may mean within one or more standard deviations, or within ±30%, 20%, 10%, 5% of the stated value.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.” In the specification and the claims, the phrase “at least one of” is intended to include the meaning of “at least one selected from the group of” for the purpose of its meaning and interpretation. For example, “at least one of A and B” may be understood to mean “A, B, or A and B.”

Unless otherwise defined or implied, all terms used herein (including technical and scientific terms) have the same meaning as commonly understood by those skilled in the art to which the present disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

Hereinafter, embodiments will be described with reference to the accompanying drawings.

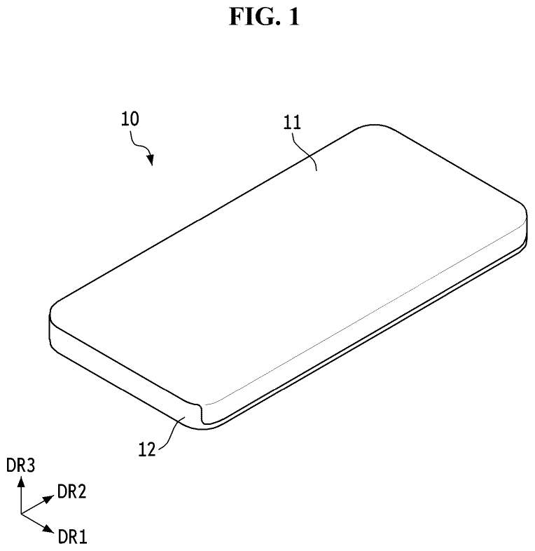

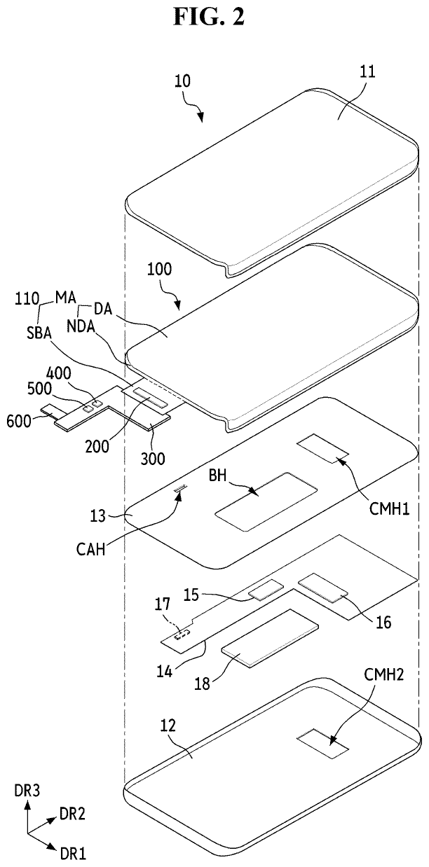

FIG. 1 is a perspective view showing an electronic device according to one or more embodiments. FIG. 2 is an exploded perspective view of the electronic device shown in FIG. 1.

Referring to FIG. 1, an electronic device 10 according to one or more embodiments is a device having a function of displaying an image in a display area. The electronic device 10 may provide portability. For example, the electronic device 10 may be a portable electronic device such as a mobile phone, a smartphone, a tablet personal computer (PC), a smart watch, a watch phone, a mobile communication terminal, an electronic notebook, an electronic book, a portable multimedia player (PMP), a navigation device and an ultra-mobile PC (UMPC).

However, the electronic device 10 according to one or more embodiments is not limited to a portable electronic device, and may be a large-sized device such as a television, a laptop computer, a monitor, a billboard, and/or an Internet-of-Things (IoT) device.

The electronic device 10 according to one or more embodiments may include a cover window 11 and a lower cover 12, which are provided as a housing to protect a display device 100 (see FIG. 2).

Referring to FIG. 2, the electronic device 10 may further include the display device 100, a bracket 13, and a main circuit board 14, which are accommodated between the cover window 11 and the lower cover 12.

The display device 100 may include a main region MA including a display area DA where an image is displayed and a non-display area NDA around an edge or a periphery of the display area DA, and a sub-region SBA protruding from one side of the main region MA.

The display device 100 may further include a display driving circuit 200 disposed in the sub-region SBA, a display circuit board 300 bonded to one side of the sub-region SBA, a touch driving circuit 400 mounted on the display circuit board 300, a scanning driving circuit 500, and a cable 600 extending from one side of the display circuit board 300.

In the present specification, a first direction DR1 may be a direction parallel to a short side of the electronic device 10 in a plan view, that is, a horizontal direction of the electronic device 10. A second direction DR2 may be a direction parallel to a long side of the electronic device 10 in a plan view, that is, a vertical direction of the electronic device 10. A third direction DR3 may be a thickness direction of the electronic device 10.

The electronic device 10 may have a shape close to a rectangular shape in a plan view. For example, the electronic device 10 may have a rectangular shape, in a plan view, having a short side in the first direction DR1 and a long side in the second direction DR2. A corner where the short side in the first direction DR1 and the long side in the second direction DR2 meet may be right-angled or rounded with a suitable curvature (e.g., a predetermined curvature). The planar shape of the electronic device 10 is not limited to the rectangular shape, and may be formed in another polygonal shape, a circular shape, or an elliptical shape.

The cover window 11 may be disposed on the display device 100 to cover the top surface of the display device 100. The cover window 11 may serve to protect the top surface of the display device 100.

The cover window 11 may include a light transmitting portion that is transparent and a light blocking portion that is opaque.

The light transmitting portion may overlap the display area DA of the display device 100 in the third direction DR3, and the light blocking portion may overlap the non-display area NDA of the display device 100 in the third direction DR3.

The cover window 11 may include a top surface portion forming the top surface of the electronic device 10, a left surface portion forming the left side surface of the electronic device 10, and a right surface portion forming the right side surface of the electronic device 10. The left surface portion of the cover window 11 may extend from the left side of the top surface portion, and the right surface portion thereof may extend from the right side of the top surface portion.

Each of the top, left, and right surface portions of the cover window 11 may include the light transmitting portion and the light blocking portion.

The light transmitting portion of the cover window 11 may be disposed on most of each of the top, left, and right surface portions of the cover window 11.

The light blocking portion of the cover window 11 may be disposed at the upper edge and lower edge of the top surface portion of the cover window 11, the upper edge, left edge, and lower edge of the left surface portion of the cover window 11, and the upper edge, right edge, and lower edge of the right surface portion of the cover window 11.

The display device 100 may be disposed below the cover window 11.

That is, the cover window 11 may be disposed on the display device 100.

The display device 100 may include a top surface portion facing the top surface portion of the cover window 11, a left surface portion facing the left surface portion of the cover window 11, and a right surface portion facing the right surface portion of the cover window 11. The left surface portion of the display device 100 may extend from the left side of the top surface portion, and the right surface portion of the display device 100 may extend from the right side of the top surface portion.

The display device 100 may include the main region MA serving as a display surface and the sub-region SBA protruding from at least a part of one side of the main region MA.

The main region MA may include the display area DA displaying an image and the non-display area NDA that is a peripheral area of the display area DA.

The display area DA may be disposed in most of the main region MA. The display area DA may be disposed at the center of the main region MA.

In other words, each of the top, left, and right surface portions of the display device 100 may include the display area DA and the non-display area NDA.

The display area DA may be disposed on most of each of the top, left, and right surface portions of the display device 100.

The non-display area NDA may be disposed outside the display area DA. The non-display area NDA may be an edge area of the main region MA.

The non-display area NDA may be disposed at the upper edge and lower edge of the top surface portion of the display device 100, the upper edge, left edge, and lower edge of the left surface portion of the display device 100, and the upper edge, right edge, and lower edge of the right surface portion of the display device 100.

The sub-region SBA may protrude from one side of the main region MA in the second direction DR2.

The length of the sub-region SBA in the first direction DR1 may be less than or equal to the length of the main region MA in the first direction DR1. The length of the sub-region SBA in the second direction DR2 may be less than the length of the main region MA in the second direction DR2, but is not limited thereto.

Because a part of the sub-region SBA is transformed to be bent, another part of the sub-region SBA may overlap the main region MA in the third direction DR3.

The display driving circuit 200 may be mounted on the sub-region SBA, and the display circuit board 300 may be attached to the sub-region SBA.

One end of the display circuit board 300 may be attached to pads disposed at the lower edge of the sub-region SBA of the display device 100 by using an anisotropic conductive film.

The display circuit board 300 may be a flexible printed circuit board (FPCB) which is bendable, a rigid printed circuit board (PCB) which maintains a flat shape, or a composite printed circuit board (PCB) having both of the rigid printed circuit board and the flexible printed circuit board.

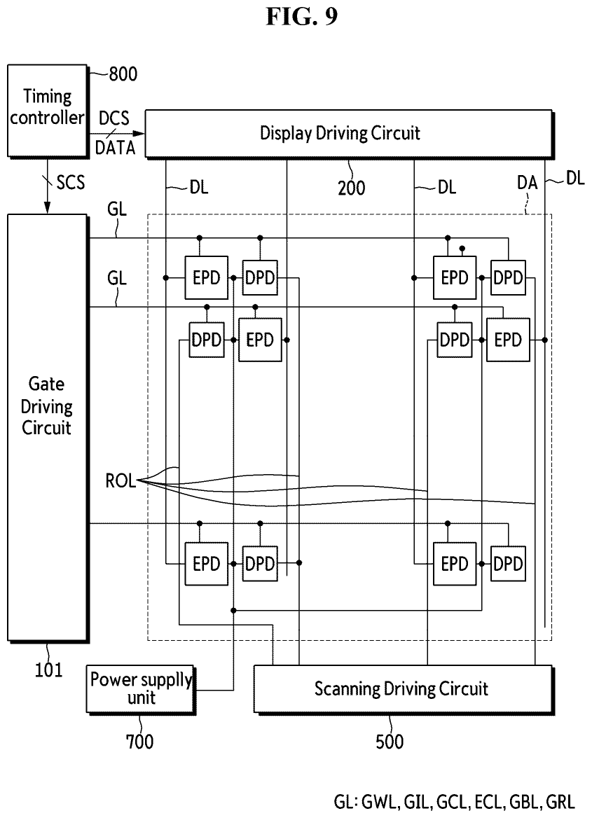

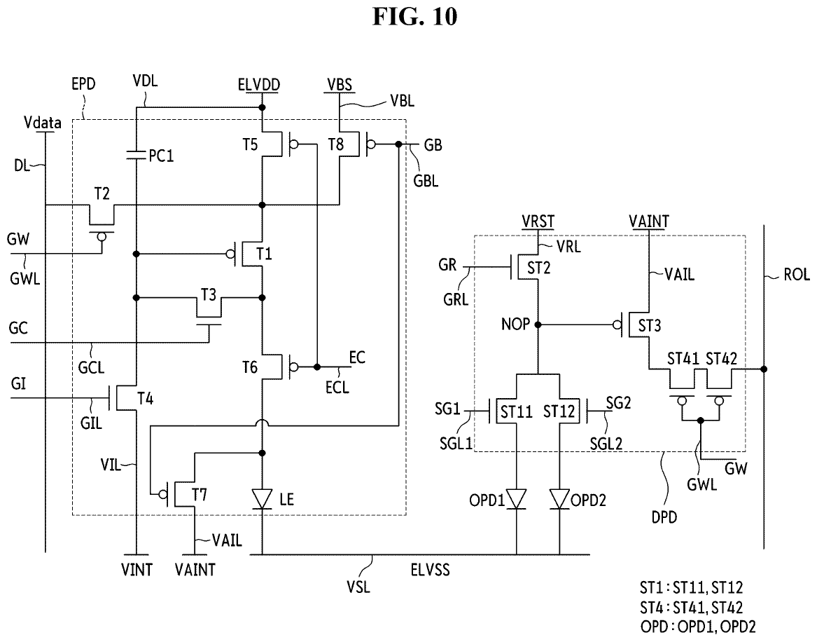

Based on control signals, power, and voltages supplied from the display circuit board 300, the display driving circuit 200 may transmit a data signal Vdata (see FIG. 10) of each of light emitting pixel drivers EPD (see FIG. 9) of the display area DA to data lines DL (see FIG. 9).

The display driving circuit 200 may be provided as an integrated circuit (IC) and mounted on the sub-region SBA of the display device 100 by a chip on glass (COG) method, a chip on plastic (COP) method, and/or an ultrasonic method. However, this is only an example, and the present disclosure is not limited thereto. For example, the display driving circuit 200 may be mounted on the display circuit board 300.

According to one or more embodiments, the touch driving circuit 400 and the scanning driving circuit 500 may be further mounted in the sub-region SBA of the display device 100.

Alternatively, as shown in FIG. 2, the touch driving circuit 400 and the scanning driving circuit 500 may be mounted on the display circuit board 300.

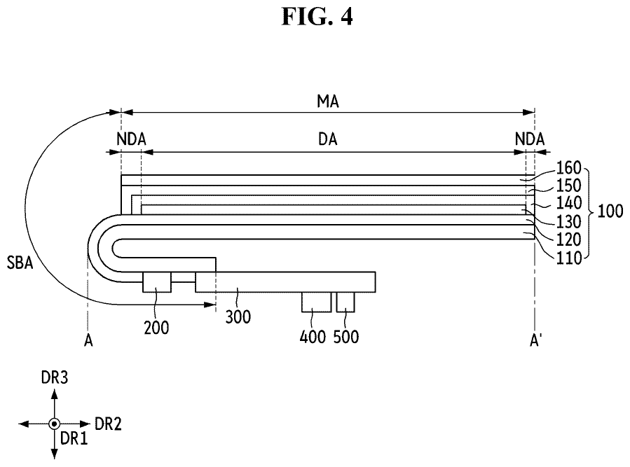

The touch driving circuit 400 may be electrically connected to a touch sensor layer 150 (see FIG. 4) of the display device 100.

The scanning driving circuit 500 may collect light sensing signals by light sensing elements OPD (see FIG. 10) through light sensing pixel drivers DPD (see FIG. 9) and read-out lines ROL (see FIG. 9) of the display area DA.

As shown in FIG. 2, the bracket 13 may be disposed under the display device 100.

The bracket 13 may include plastic and/or metal. The bracket 13 may include a first camera hole CMH1 into which a camera device 16 is inserted, a battery hole BH into which a battery 18 is disposed, and a cable hole CAH through which the cable 600 connected to the display circuit board 300 passes.

The main circuit board 14 and the battery 18 may be disposed under the bracket 13.

The main circuit board 14 may be a printed circuit board (PCB) or a flexible printed circuit board (FPCB).

The main circuit board 14 may include a main processor 15, the camera device 16, and a main connector 17. The main processor 15 may be formed as an integrated circuit (IC).

The camera device 16 may be disposed on both the top surface and the bottom surface of the main circuit board 14, the main processor 15 may be disposed on the top surface of the main circuit board 14, and the main connector 17 may be disposed on the bottom surface of the main circuit board 14.

The main processor 15 may control all functions of the electronic device 10.

For example, the main processor 15 may output digital video data to the display driving circuit 200 through the display circuit board 300 such that the display device 100 displays an image. In addition, the main processor 15 may receive touch data including user's touch coordinates from the touch driving circuit 400, determine whether or not the user has touched or approached, and then perform an operation corresponding to the user's touch input or approach input. For example, the main processor 15 may perform an operation or execute an application indicated by an icon touched by the user.

In addition, the main processor 15 may receive scanning data from the scanning driving circuit 500, and perform an operation or execute an application based on whether or not the scanning data is valid.

The main processor 15 may be an application processor formed of an integrated circuit (IC), a central processing unit (CPU), or a system chip.

The camera device 16 may process an image frame of a still image and/or video obtained by an image sensor in a camera mode and output it to the main processor 15.

A cable 600 having passed through the cable hole CAH of the bracket 13 may be connected to the main connector 17. Thus, the main circuit board 14 may be electrically connected to the display circuit board 300.

The battery 18 may be disposed so as not to overlap the main circuit board 14 in the third direction DR3. The battery 18 may overlap the battery hole BH of the bracket 13 in the third direction DR3.

In addition, the main circuit board 14 may be further equipped with a mobile communication module capable of transmitting and receiving radio signals with at least one of a base station, an external terminal, or a server in a mobile communication network. The radio signal may include various types of data according to transmission and reception of a voice signal, a video call signal, and/or a text/multimedia message.

The lower cover 12 may be disposed below the main circuit board 14 and the battery 18. The lower cover 12 may be fixed by being fastened to the bracket 13. The lower cover 12 may form the upper side surface, lower side surface, and bottom surface of the electronic device 10. The lower cover 12 may include plastic, metal, or both plastic and metal.

The lower cover 12 may include a second camera hole CMH2 through which the bottom surface of the camera device 16 is exposed. The position of the camera device 16 and the positions of the first camera hole CMH1 and the second camera hole CMH2 corresponding to the camera device 16 are not limited by the illustration in FIG. 2.

Next, the display device 100 will be described.

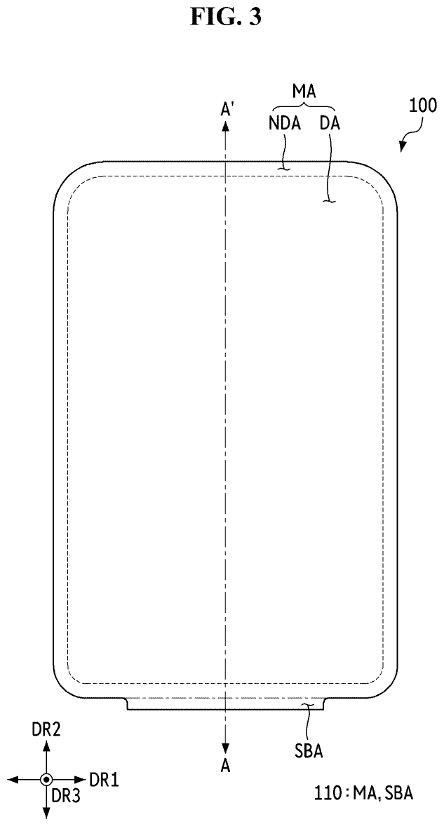

FIG. 3 is a plan view illustrating the display device of FIG. 2. FIG. 4 is a cross-sectional view taken along the line A-A′ of FIG. 3.

FIGS. 3 and 4 illustrate the display device 100 with a part of the sub-region SBA in a bent state.

The display device 100 may be a light emitting display device such as an organic light emitting display using an organic light emitting diode (OLED), a quantum dot light emitting display including a quantum dot light emitting layer, an inorganic light emitting display including an inorganic semiconductor, and a micro light emitting display using a micro or nano light emitting diode (LED). In the following description, it is assumed that the display device 100 is an organic light emitting display device. However, the present disclosure is not limited thereto, and may be applied to a display device including an organic insulating material, an organic light emitting material, and a metal material.

The display device 100 may be formed to be flat, but is not limited thereto. For example, the display device 100 may include a curved portion formed at left and right ends and having a constant curvature or a varying curvature. In addition, the display device 100 may be formed to be flexible so that it can be curved, bent, folded, and/or rolled.

Referring to FIG. 3, at least one surface of the display device 100 includes the main region MA from which light for displaying an image is emitted.

The display area DA may, in a plan view, be formed in a rectangular shape having short sides in a first direction DR1 and long sides in a second direction DR2 crossing the first direction DR1. The corner where the short side in the first direction DR1 and the long side in the second direction DR2 meet may be rounded to have a suitable curvature (e.g., a predetermined curvature) or may be right-angled. The planar shape of the display area DA is not limited to the rectangular shape, and may be formed in another polygonal shape, a circular shape or an elliptical shape.

The display area DA may be disposed in most of the main region MA. The display area DA may be disposed at the center of the main region MA.

Referring to FIG. 4, the display device 100 may further include the sub-region SBA protruding in the second direction DR2 from at least a part of one side of the main region MA.

Because a part of the sub-region SBA is transformed into a bent shape, another part of the sub-region SBA may be disposed on the rear surface of the display device 100.

According to one or more embodiments, the display device 100 includes a substrate 110, a circuit layer 120 disposed on the substrate 110, and an element layer 130 disposed on the circuit layer 120.

The display device 100 may further include an encapsulation layer 140 disposed on the element layer 130, and a touch sensor layer 150 disposed on the encapsulation layer 140.

The display device 100 may further include a polarization layer 160 disposed on the touch sensor layer 150, in order to reduce reflection of external light.

The substrate 110 may include the main region MA corresponding to the display surface, and the sub-region SBA protruding in the second direction DR2 from at least a part of one side of the main region MA.

The main region MA of the substrate 110 may include the display area DA from which light is emitted, and the non-display area NDA disposed around the display area DA.

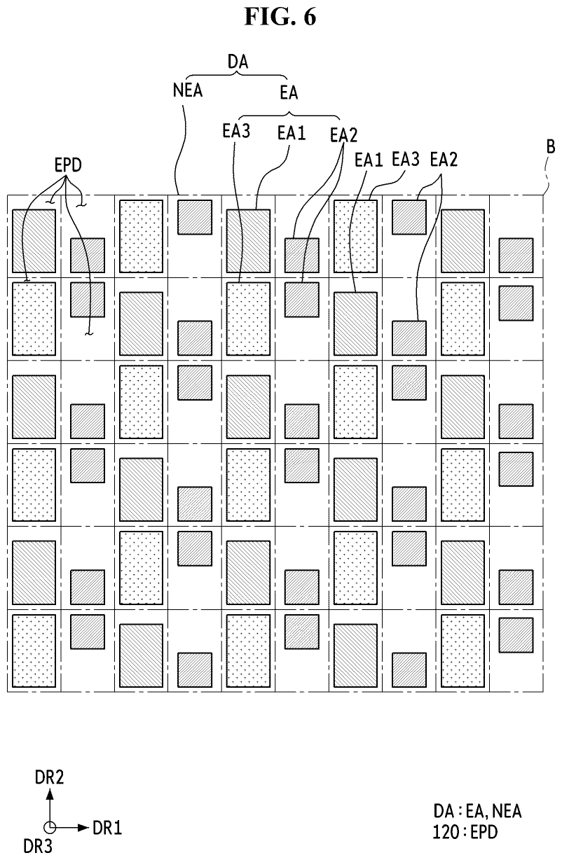

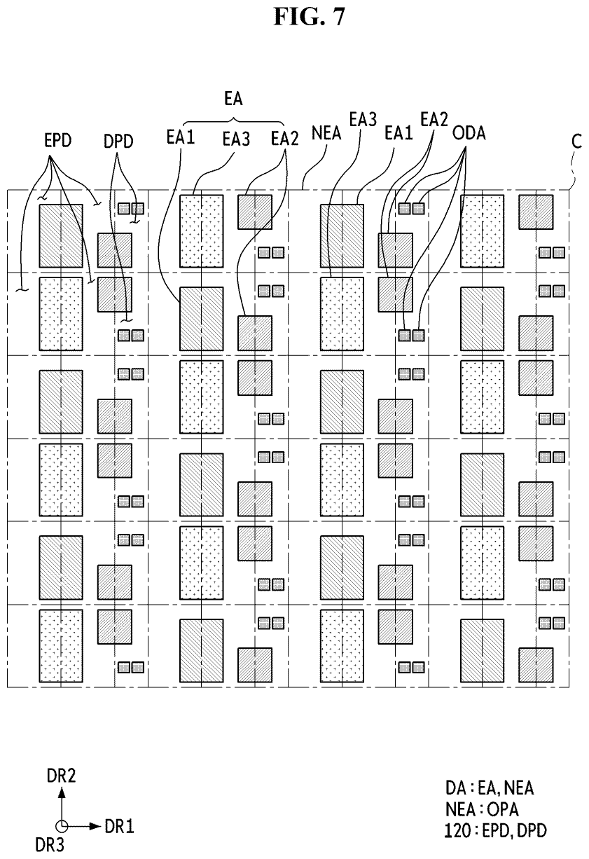

According to one or more embodiments, the element layer 130 may include light emitting elements LE (see FIG. 10) respectively disposed in emission areas EA (see FIGS. 6 and 7), and the light sensing elements OPD (see FIG. 10) respectively disposed in light sensing areas ODA (see FIG. 7).

According to one or more embodiments, the circuit layer 120 may include the light sensing pixel drivers DPD (see FIGS. 7 and 9) electrically connected to the light sensing elements OPD (see FIG. 10), and the read-out lines ROL (see FIG. 9) electrically connected between the light sensing pixel drivers DPD and the scanning driving circuit 500.

Further, the circuit layer 120 may further include the light emitting pixel drivers EPD (see FIGS. 6, 7, and 9) electrically connected to the light emitting elements LE, and the data lines DL (see FIG. 9) electrically connected to the light emitting pixel drivers EPD.

The encapsulation layer 140 may cover the element layer 130. The encapsulation layer 140 may include a structure in which two or more inorganic layers and at least one organic layer are alternately stacked.

The touch sensor layer 150 may be disposed on the encapsulation layer 140 and may correspond to the main region MA. The touch sensor layer 150 may include touch electrodes for sensing a touch of a person or an object.

The polarization layer 160 blocks external light reflected from the touch sensor layer 150, the encapsulation layer 140, the element layer 130, and the circuit layer 120, and the interfaces thereof, and this is to prevent the deterioration of visibility of an image due to external light reflection.

In one or more embodiments, as a part of the sub-region SBA is transformed into a bent shape, the display driving circuit 200 mounted in the sub-region SBA, and the display circuit board 300 connected to one side of the sub-region SBA may be disposed under the substrate 110.

The display driving circuit 200 may be electrically connected to the data lines DL (see FIG. 9) of the circuit layer 120. The display driving circuit 200 may transmit the data signals Vdata (see FIG. 10) of the light emitting pixel drivers EPD through the data lines DL based on control signals and power voltages supplied from the display circuit board 300.

The display driving circuit 200 may be provided as an integrated circuit (IC) and mounted on the sub-region SBA of the display device 100 by a chip on glass (COG) method, a chip on plastic (COP) method, or an ultrasonic method. However, this is only an example, and the present disclosure is not limited thereto. For example, the display driving circuit 200 may be mounted on the display circuit board 300.

One end of the display circuit board 300 may be attached onto pads disposed on one edge of the sub-region SBA of the display device 100 by using an anisotropic conductive film.

The display circuit board 300 may be a flexible printed circuit board (FPCB) which is bendable, a rigid printed circuit board (PCB) which maintains a flat shape, or a composite printed circuit board having both of the rigid printed circuit board and the flexible printed circuit board.

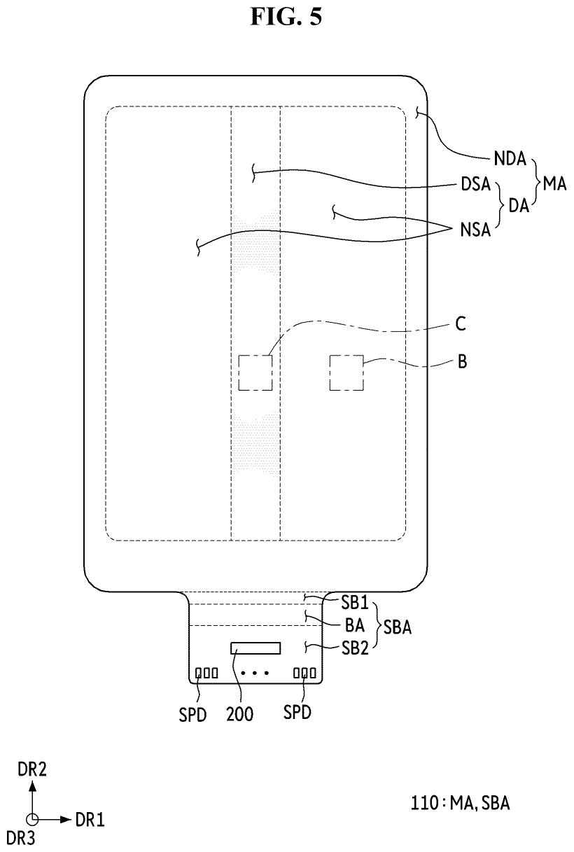

The display circuit board 300 may be connected to signal pads SPD (see FIG. 5) disposed on one side of the sub-region SBA.

The touch driving circuit 400 and the scanning driving circuit 500 may be mounted on the display circuit board 300.

The touch driving circuit 400 may be electrically connected to the touch sensor layer 150 of the display device 100.

The touch driving circuit 400 may apply a touch driving signal to driving lines of the touch sensor layer 150, and receive a touch sensing signal from sensing lines. Further, the touch driving circuit 400 may detect charge variation amounts of capacitances based on the touch sensing signal, thereby determining whether a user has touched or approached.

The user's touch means that an object such as a pen or a user's finger is in direct contact with the top surface of the cover window disposed on the touch sensor layer. The user's approach means that the object such as the pen or the user's finger hovers over the top surface of the cover window.

The touch driving circuit 400 may output touch data including the user's touch coordinates to the main processor 15 (see FIG. 2).

The scanning driving circuit 500 may be electrically connected to the read-out lines ROL of the circuit layer 120.

The scanning driving circuit 500 may collect light sensing signals of the light sensing elements OPD (see FIG. 10) disposed in the light sensing areas ODA of the main region MA through the light sensing pixel drivers DPD and the read-out lines ROL. Further, based on the collected light sensing signals, the scanning driving circuit 500 may output, to the main processor 15, scanning data about the shape of an object in contact with a screen by detecting differences in the amount of light reflected by the object in contact with the screen.

FIG. 5 is a schematic diagram illustrating the substrate of FIG. 4 according to one or more embodiments. FIG. 6 is a schematic diagram showing a part B of FIG. 5. FIG. 7 is a schematic diagram showing a part C of FIG. 5.

Referring to FIG. 5, the substrate 110 of the display device 100 according to one or more embodiments may include the main region MA and the sub-region SBA protruding from at least a part of one side of the main region MA.

The sub-region SBA may include a bending area BA that is transformed into a bent shape, a first sub-region SB1 disposed between one side of the main region MA and one side of the bending area BA, and a second sub-region SB2 extending from the other side of the bending area BA.

The main region MA may include the display area DA and the non-display area NDA.

According to one or more embodiments, at least a part of the display area DA may be a display sensing area DSA that provides a display function and a scanning function.

The display area DA may include the display sensing area DSA that provides both the display function and the scanning function, and a non-sensing area NSA that provides only the display function.

As illustrated in FIGS. 6 and 7, each of the non-sensing area NSA and the display sensing area DSA may include the emission areas EA (see FIGS. 6 and 7) where light is emitted, and a non-emission area NEA (see FIGS. 6 and 7) that is a separation area between the emission areas EA and where light is not emitted.

Further, as illustrated in FIG. 7, the display sensing area DSA may further include the light sensing areas ODA (see FIG. 7) arranged in the non-emission area NEA as well as the emission areas EA (see FIGS. 6 and 7).

Each of the emission areas EA may be a unit area that emits light in a wavelength band corresponding to one color of two or more different colors with a luminance corresponding to an image signal.

As illustrated in FIGS. 6 and 7, each of the emission areas EA may be disposed in a quadrilateral shape.

However, this is only an example, and the planar shape of the emission areas EA according to one or more embodiments is not limited to that illustrated in FIGS. 6 and 7. That is, the emission areas EA may have a polygonal shape such as a rhombus shape or a hexagonal shape other than a rectangular shape, a circular shape, or an elliptical shape in a plan view.

The emission areas EA may include first emission areas EA1 that emit light in a first wavelength band, second emission areas EA2 that emit light in a second wavelength band lower than the first wavelength band, and third emission areas EA3 that emit light in a third wavelength band lower than the second wavelength band.

For example, the first wavelength band may be from about 600 nm to about 750 nm and may correspond to a red color. The second wavelength band may be from about 480 nm to about 560 nm and may correspond to a green color. The third wavelength band may be from about 370 nm to about 460 nm and may correspond to a blue color.

However, this is only an example, and the first wavelength band, the second wavelength band, and the third wavelength band according to one or more embodiments are not limited thereto.

Because the emission areas EA include the first emission area EA1, the second emission area EA2, and the third emission area EA3, each of unit pixels may be provided by a combination of one or more first emission areas EA1, one or more second emission areas EA2, and one or more third emission areas EA3 adjacent to each other from among the emission areas EA.

Each of the unit pixels may be a unit for displaying various colors including white. That is, lights of various colors displayed by the unit pixels UPX may be implemented as a mixture of lights emitted from two or more emission areas EA included in each unit pixel.

The third emission area EA3 may have a width greater than that of the first emission area EA1, and the first emission area EA1 may have a width greater than that of the second emission area EA2. However, this is merely an example, and the width of each of the emission areas EA is not limited to that illustrated in FIGS. 6 and 7.

The first emission areas EA1 and the third emission areas EA3 may be alternately arranged along the second direction DR2.

The second emission areas EA2 may be arranged side by side along the second direction DR2.

Further, the first emission area EA1, the second emission area EA2, the third emission area EA3, and the second emission area EA2 may be arranged repeatedly along the first direction DR1.

In this case, each of the unit pixels may include one first emission area EA1 and one third emission area EA3 adjacent to each other in the second direction DR2, and two second emission areas EA2 adjacent thereto in the first direction DR1. However, this is only an example, and the arrangement pattern of the emission areas EA and the components of the unit pixel PX according to one or more embodiments are not limited to the above description.

As illustrated in FIG. 7, according to one or more embodiments, the display sensing area DSA, which is at least a part of the display area DA, includes the light sensing areas ODA arranged in the non-emission area NEA.

For example, at least one of the light sensing areas ODA may be disposed adjacent to one side of each of the second emission areas EA2 in the second direction DR2.

For example, two light sensing areas ODA adjacent in the first direction DR1 may be disposed adjacent to one side of one second emission area EA2 in the second direction DR2, and two other light sensing areas ODA adjacent in the first direction DR1 may be disposed adjacent to the other side of another second emission area EA2 in the second direction DR2.

In this case, four light sensing areas ODA may be arranged in a 2×2 matrix form in the non-emission area NEA between one second emission area EA2 and another second emission area EA2 facing each other in the second direction DR2.

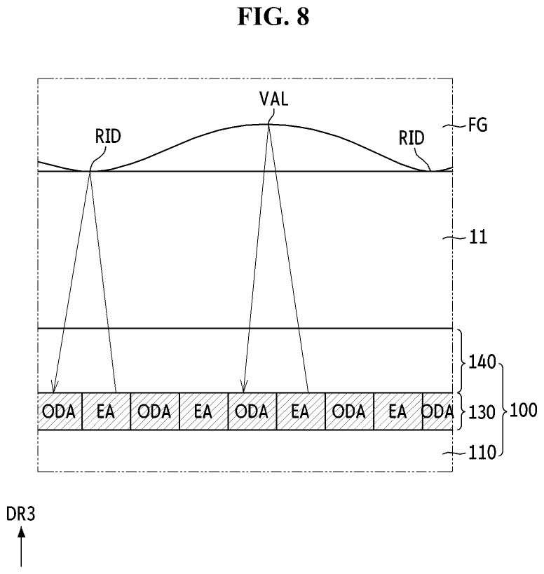

FIG. 8 is a schematic diagram showing a scanning function by light sensing elements disposed in the light sensing areas of FIG. 7.

Referring to FIG. 8, the display device 100 according to one or more embodiments may include the light sensing elements OPD (see FIG. 10) disposed in the light sensing areas ODA, and thus may provide a scanning function to detect the shape of an object in contact with the screen.

The fingerprint of a user's finger FG in contact with the cover window 11 includes ridges RID and valleys VAL between the ridges RID. The ridges RID in the fingerprint are in contact with the cover window 11. However, the valleys VAL in the fingerprint are spaced (e.g., spaced apart) from the cover window 11. That is, the top surface of the cover window 11 facing the valleys VAL is in contact with air.

Light emitted from the emission areas EA may be reflected by the user's finger FG in contact with the cover window 11 and detected by the light sensing elements OPD of the light sensing areas ODA. However, because the refractive index of the finger FG is different from that of the air, the amount of light reflected from the ridge RID may be different from the amount of light reflected from the valley VAL.

Accordingly, based on the difference in the amount of light incident on the light sensing elements OPD, the ridge RID and the valley VAL of the fingerprint FG may be derived, so that the fingerprint FG pattern of the finger may be detected.

FIG. 9 is a block diagram showing the circuit layer of FIG. 4.

Referring to FIG. 9, the circuit layer 120 of the display device 100 according to one or more embodiments may include the light emitting pixel drivers EPD electrically connected to the light emitting elements LE (see FIG. 10) disposed in the emission areas EA of the display area DA, the light sensing pixel drivers DPD electrically connected to the light sensing elements OPD (see FIG. 10) disposed in the light sensing areas ODA of the display sensing area DSA of the display area DA, the data lines DL electrically connected to the light emitting pixel drivers EPD, and the read-out lines ROL electrically connected to the light sensing pixel drivers DPD.

According to one or more embodiments, the display device 100 may further include the display driving circuit 200 that transmits the data signals Vdata (see FIG. 10) of the light emitting pixel drivers EPD to the data lines DL in order to control the luminance of each of the light emitting elements LE (see FIG. 10).

According to one or more embodiments, the display device 100 may further include the scanning driving circuit 500 that collects light sensing signals by the light sensing elements OPD (see FIG. 10).

The read-out lines ROL may be electrically connected between the light sensing pixel drivers DPD and the scanning driving circuit 500.

According to one or more embodiments, the display device 100 may further include a gate driving circuit 101 that supplies one or more gate signals to the light emitting pixel drivers EPD and the light sensing pixel drivers DPD, a power supply unit 700 that supplies powers and voltages to the light emitting pixel drivers EPD and the light sensing pixel drivers DPD, and a timing controller 800 that controls an operation timing.

The timing controller 800 receives an image signal supplied from the outside of the display device 100.

The timing controller 800 may output image data DATA and a data control signal DCS to the display driving circuit 200.

The timing controller 800 may generate a scan control signal SCS for controlling the operation timing of the gate driving circuit 101.

The display driving circuit 200 may convert the image data DATA into analog data voltages and output them to the data lines DL.

The gate driving circuit 101 may generate gate signals in response to the scan control signal SCS and sequentially output the gate signals to gate lines GL.

The gate lines GL may include a scan write line GWL that transmits a scan write signal GW (see FIG. 10), a scan initialization line GIL that transmits a scan initialization signal GI (see FIG. 10), a gate control line GCL that transmits a gate control signal GC (see FIG. 10), emission control lines ECL that transmit emission control signals EC (see FIG. 10), a bias control line GBL that transmits a bias control signal GB (see FIG. 10), and a reset control line GRL that transmits a reset control signal GR (see FIG. 10).

The gate signals may have pulses that vary to a first gate level voltage or a second gate level voltage.

The power supply unit 700 may supply various types of powers and voltages required to drive the light emitting pixel drivers EPD and the light sensing pixel drivers DPD.

For example, the power supply unit 700 may supply a first power ELVDD (see FIG. 10) and a second power ELVSS (see FIG. 10) for driving the light emitting elements LE, and a first initialization voltage VINT (see FIG. 10) and a second initialization voltage VAINT (see FIG. 10) for initializing the light emitting pixel drivers EPD.

In addition, the power supply unit 700 may further supply a reset voltage VRST (see FIG. 10) for resetting the light sensing pixel drivers DPD.

The scanning driving circuit 500 may be electrically connected to the light sensing elements OPD (see FIG. 10) through the read-out lines ROL and the light sensing pixel drivers DPD.

Each of the light sensing elements OPD (see FIG. 10) may generate a photocurrent corresponding to the amount of light incident on the light sensing element OPD, and the light sensing pixel drivers DPD may transmit a light sensing signal to the read-out lines ROL based on the photocurrent by the light sensing elements OPD (see FIG. 10).

The scanning driving circuit 500 may collect the light sensing signals through the read-out lines ROL, and may sense the user's fingerprint shape based on the light sensing signals.

The scanning driving circuit 500 may generate scanning data depending on the magnitude of each of the light sensing signals and transmit it to the main processor, and the main processor 15 (see FIG. 2) may compare the scanning data with reference data and execute an application based on whether the scanning data matches the user's fingerprint.

FIG. 10 is an equivalent circuit diagram of the light emitting pixel driver and the light sensing pixel driver shown in FIG. 9.

Referring to FIG. 10, the light emitting elements LE of the element layer 130 (see FIG. 4) may be respectively electrically connected to the light emitting pixel drivers EPD of the circuit layer 120 (see FIG. 4).

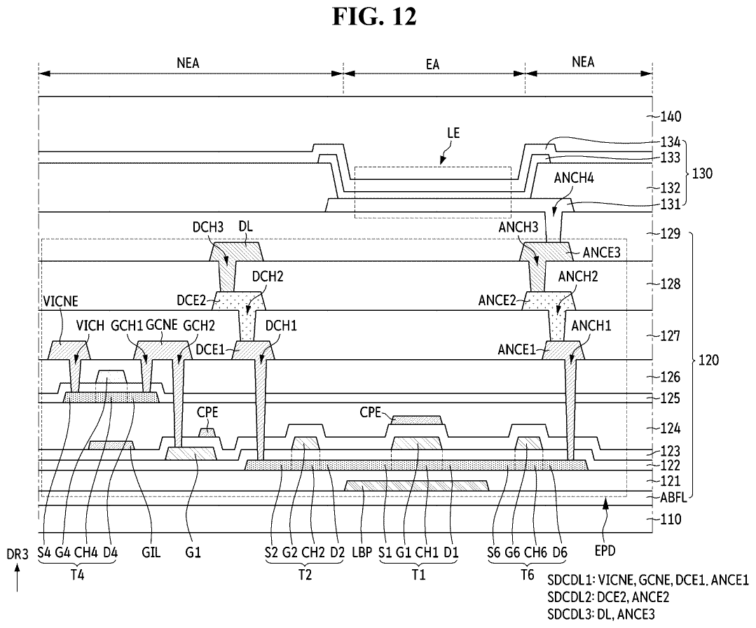

For example, anode electrodes 131 (see FIG. 12) of the light emitting elements LE may be electrically connected to the light emitting pixel drivers EPD, the light emitting pixel drivers EPD may be electrically connected to a first power source ELVDD, and cathode electrodes 134 (see FIG. 12) of the light emitting elements LE may be electrically connected to a second power source ELVSS having a voltage level lower than that of the first power source ELVDD.

The circuit layer 120 (see FIG. 4) may further include a first power line VDL for transmitting the first power ELVDD, a first initialization voltage line VIL for transmitting the first initialization voltage VINT, a second initialization voltage line VAIL for transmitting the second initialization voltage VAINT, and a bias voltage line VBL for transmitting a bias voltage VBS.

The circuit layer 120 may further include the scan write line GWL for transmitting the scan write signal GW, the scan initialization line GIL for transmitting the scan initialization signal GI, an emission control line ECL for transmitting the emission control signal EC, the gate control line GCL for transmitting the gate control signal GC, and the bias control line GBL for transmitting the bias control signal GB.

Each of the light emitting pixel drivers EPD may include a first transistor T1 generating a driving current, two or more transistors T2 to T8 electrically connected to the first transistor T1, and at least one pixel capacitor PC1.

The first transistor T1 is connected in series with the light emitting element LE between the first power source ELVDD and the second power source ELVSS.

That is, the first electrode (e.g., the source electrode) of the first transistor T1 may be electrically connected to the first power line VDL through the fifth transistor T5. Further, the second electrode (e.g., the drain electrode) of the first transistor T1 may be electrically connected to the anode electrode 131 (see FIG. 12) of the light emitting element LE through the sixth transistor T6.

The first electrode of the first transistor T1 may be electrically connected to the data line DL through a second transistor T2.

The pixel capacitor PC1 may be electrically connected between the gate electrode of the first transistor T1 and the first power line VDL.

Accordingly, the voltage difference between the gate electrode of the first transistor T1 and the first electrode of the first transistor T1 may be maintained for a critical period by the pixel capacitor PC1.

The second transistor T2 may be electrically connected between the first electrode of the first transistor T1 and the data line DL. The second transistor T2 may be turned on by the scan write signal GW of the scan write line GWL.

The third transistor T3 may be electrically connected between the gate electrode of the first transistor T1 and the second electrode of the first transistor T1. The third transistor T3 may be turned on by the gate control signal GC of the gate control line GCL to diode-connect the first transistor T1.

The fourth transistor T4 may be connected between the gate electrode of the first transistor T1 and the first initialization voltage line VIL. The fourth transistor T4 may be turned on by the scan initialization signal GI of the scan initialization line GIL to initialize the first transistor T1.

The third transistor T3 and the fourth transistor T4 may be provided as N-type MOSFETs.

The fifth transistor T5 may be electrically connected between the first electrode of the first transistor T1 and the first power line VDL.

The sixth transistor T6 may be electrically connected between the second electrode of the first transistor T1 and the anode electrode 131 (e.g., see FIG. 12) of the light emitting element LE.

The fifth transistor T5 and the sixth transistor T6 may be turned on by the emission control signal EC of the emission control line ECL.

The seventh transistor T7 may be electrically connected between the anode electrode of the light emitting element LE and the second initialization voltage line VAIL. The seventh transistor T7 may be turned on by the bias control signal GB of the bias control line GBL.

The eighth transistor T8 may be connected between the first electrode of the first transistor T1 and the bias voltage line VBL.

The eighth transistor T8 may be turned on by the bias control signal GB of the bias control line GBL.

When the scan write signal GW is transmitted to the light emitting pixel driver EPD, the second transistor T2 is turned on, and the data signal Vdata of the data line DL may be transmitted to the first electrode of the first transistor T1 through the turned-on second transistor T2. Therefore, the voltage difference corresponding to the data signal Vdata and the first power source ELVDD may be generated between the gate electrode of the first transistor T1 and the first electrode of the first transistor T1.

At this time, if the voltage difference between the gate electrode of the first transistor T1 and the first electrode of the first transistor T1, i.e., a gate-source voltage difference, becomes greater than or equal to a threshold voltage, the first transistor T1 is turned on, so that the drain-source current of the first transistor T1 may be generated to have a magnitude corresponding to the data signal Vdata.

Further, when the emission control signal EC is transmitted to the light emitting pixel driver EPD, the fifth transistor T5 and the sixth transistor T6 are turned on, so that the first transistor T1 and the light emitting element LE may be connected in series between the first power line VDL and the second power line VSL.

Accordingly, the drain-source current of the first transistor T1 corresponding to the data signal Vdata may be transmitted as a driving current of the light emitting element LE.

Accordingly, the light emitting element LE may emit light having a luminance corresponding to the data signal Vdata.

From among the first to eighth transistors T1 to T8, the transistors T1, T2, and T5 to T8 other than the third and fourth transistor T3 and T4 may be provided as P-type MOSFETs.

The light sensing elements OPD of the element layer 130 (see FIG. 4) may be electrically connected to the light sensing pixel drivers DPD of the circuit layer 120 (see FIG. 4).

The light sensing element OPD may be a photoelectric conversion element that converts incident light into an electrical signal by generating a photocurrent corresponding to the amount of the incident light, and outputs a light sensing signal.

The light sensing element OPD may be a photodiode including a photoelectric conversion layer disposed between an anode electrode and a cathode electrode.

The light sensing element OPD may be a phototransistor or an inorganic photodiode formed of a p-n type or p-i-n type inorganic material. Alternatively, the light sensing element OPD may also be an organic photodiode including an electron donating material generating donor ions and an electron accepting material generating acceptor ions.

When light is incident, photocharges may be generated in response to the light incident on the photoelectric conversion layer, and a photocurrent may be generated between the anode electrode and the cathode electrode as the generated photocharges move.

For example, the photocharges generated in the photoelectric conversion layer of the light sensing element OPD by the incident light may be accumulated in the anode electrode of the light sensing element OPD.

According to one or more embodiments, each of the light sensing pixel drivers DPD may be electrically connected to at least one light sensing element OPD.

For example, an output node NOP of each of the light sensing pixel drivers DPD may be electrically connected to a first light sensing element OPD1 and a second light sensing element OPD2.

The anode electrodes of the first light sensing element OPD1 and the second light sensing element OPD2 may be electrically connected to the output node NOP of the light sensing pixel driver DPD, and the cathode electrodes of the first light sensing element OPD1 and the second light sensing element OPD2 may be electrically connected to the second power source ELVSS.

The circuit layer 120 (see FIG. 4) may include the reset control line GRL for transmitting the reset control signal GR for initiating a reset of the light sensing pixel drivers DPD, a reset voltage line VRL for transmitting the reset voltage VRST for resetting the light sensing pixel drivers DPD, and the read-out line ROL electrically connecting the light sensing pixel drivers DPD to the scanning driving circuit 500.

Each of the light sensing pixel drivers DPD may include two or more sensing transistors ST1, ST2, ST3, and ST4.

Each of the light sensing pixel drivers DPD may include at least one first sensing transistor ST1 electrically connected between the output node NOP and at least one light sensing element OPD1 and OPD2 from among the light sensing elements OPD, a second sensing transistor ST2 electrically connected between the output node NOP and the reset voltage line VRL that transmits the reset voltage VRST, a third sensing transistor ST3 that is electrically connected to the second initialization voltage line VAIL that transmits the second initialization voltage VAINT and is turned on according to the potential of the output node NOP, and a fourth sensing transistor ST4 electrically connected between one of the read-out lines ROL (see FIG. 9) and the third sensing transistor ST3.

As shown in FIG. 10, the third sensing transistor ST3 may be electrically connected to the second initialization voltage line VAIL. However, this is only an example. According to one or more other embodiments, the third sensing transistor ST3 may be electrically connected to another line (e.g., a sensing initialization voltage line) that transmits a sensing initialization voltage having a voltage level different from the second initialization voltage VAINT.

At least one first sensing transistor ST1 may include a first sensing sub-transistor ST11 electrically connected between the output node NOP and the anode electrode of the first light sensing element OPD1, and a second sensing sub-transistor ST12 electrically connected between the output node NOP and the anode electrode of the second light sensing element OPD2.

The first sensing sub-transistor ST11 and the second sensing sub-transistor ST12 may be turned on by different sensing gate signals SG1 and SG2.

The first sensing sub-transistor ST11 may be turned on in response to the first sensing gate signal SG1 transmitted through a first sensing gate line SGL1.

When the first sensing sub-transistor ST11 is turned on, the photocharges accumulated in the anode electrode of the first light sensing element OPD1 are transmitted to the output node NOP, thereby increasing the potential of the output node NOP.

Further, the second sensing sub-transistor ST12 may be turned on in response to the second sensing gate signal SG2 transmitted through a second sensing gate line SGL2.

When the second sensing sub-transistor ST12 is turned on, the photocharges accumulated in the anode electrode of the second light sensing element OPD2 are transmitted to the output node NOP, thereby increasing the potential of the output node NOP.

The second sensing transistor ST2 may be electrically connected between the output node NOP and the reset voltage line VRL, and may be turned on by the reset control signal GR of the reset control line GRL.

When the second sensing transistor ST2 is turned on, the potential of the output node NOP may be reset to the reset voltage VRST of the reset voltage line VRL.

The third sensing transistor ST3 may be electrically connected between the second initialization voltage line VAIL and the fourth sensing transistor ST4.

The gate electrode of the third sensing transistor ST3 may be electrically connected to the output node NOP.

The third sensing transistor ST3 may be a source follower amplifier that generates a source-drain current in proportional to the amount of electric charges of the output node NOP.

That is, when the potential of the output node NOP increases by turning on one of the first sensing sub-transistor ST11 and the second sensing sub-transistor ST12, the difference voltage between the potential of the output node NOP and the second initialization voltage VAINT becomes greater than or equal to the threshold voltage of the third sensing transistor ST3 and, thus, the third sensing transistor ST3 may be turned on.

When the third sensing transistor ST3 is turned on, the light sensing signal having a magnitude corresponding to the difference voltage between the second initialization voltage VAINT and the potential of the output node NOP may be generated.

The fourth sensing transistor ST4 may be electrically connected between the third sensing transistor ST3 and the read-out line ROL.

The fourth sensing transistor ST4 may be turned on in response to the scan write signal GW of the scan write line GWL.

The fourth sensing transistor ST4 may include a third sensing sub-transistor ST41 and a fourth sensing sub-transistor ST42 that are connected in series.

The first electrode of the third sensing sub-transistor ST41 may be electrically connected to the third sensing transistor ST3, the second electrode of the third sensing sub-transistor ST41 may be electrically connected to the first electrode of the fourth sensing sub-transistor ST42, and the second electrode of the fourth sensing sub-transistor ST42 may be electrically connected to the read-out line ROL.

In this way, malfunction in which the fourth sensing transistor ST4 is turned on during a period in which the scan write signal GW is not transmitted may be prevented, so that the potential of the read-out line ROL may be prevented from changing due to the leakage current of the fourth sensing transistor ST4.

When the third sensing sub-transistor ST41 and the fourth sensing sub-transistor ST42 are turned on, the light sensing signal generated by the third sensing transistor ST3 may be transmitted to the read-out line ROL.

Therefore, the light sensing signal by the first light sensing element OPD1 or the second light sensing element OPD2 may be transmitted to the scanning driving circuit 500 (see FIG. 4) through the light sensing pixel driver DPD and the read-out line ROL.

According to one or more embodiments, in the light sensing pixel driver DPD, the first sensing transistor ST1 and the second sensing transistor ST2 may be provided as N-type MOSFETs, and the third sensing transistor ST3 and the fourth sensing transistor ST4 may be provided as P-type MOSFETs.

As described above, according to one or more embodiments, each of the light emitting pixel driver EPD and the light sensing pixel driver DPD may include both an N-type MOSFET and a P-type MOSFET.

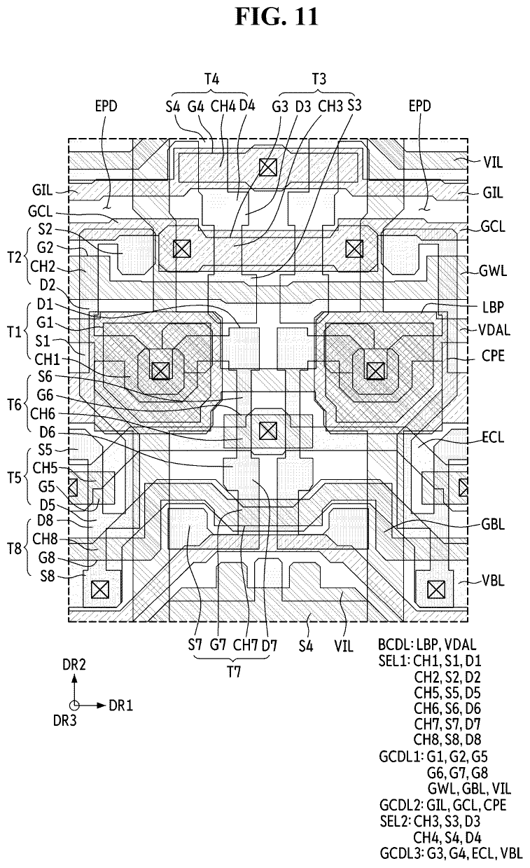

Accordingly, the circuit layer 120 may include a first semiconductor layer SEL1 (see FIG. 11) for arranging the P-type MOSFET, and a second semiconductor layer SEL2 (see FIG. 11) for arranging the N-type MOSFET.

FIG. 11 is a plan view showing transistors in two adjacent light emitting pixel drivers shown in FIGS. 6 and 7. FIG. 12 is a cross-sectional view showing the first transistor, the second transistor, the fourth transistor, the sixth transistor, and the light emitting element shown in FIG. 10.

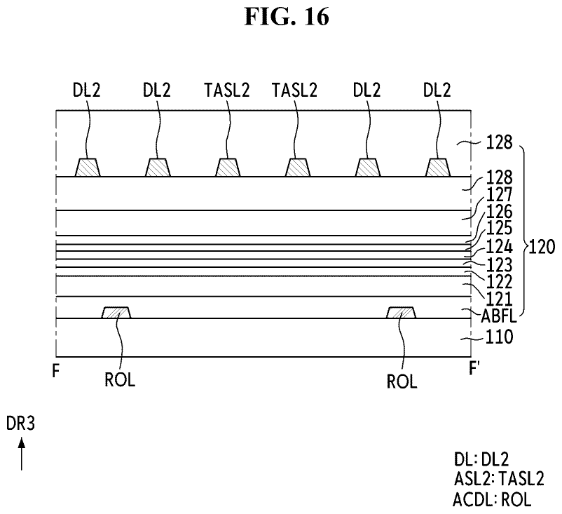

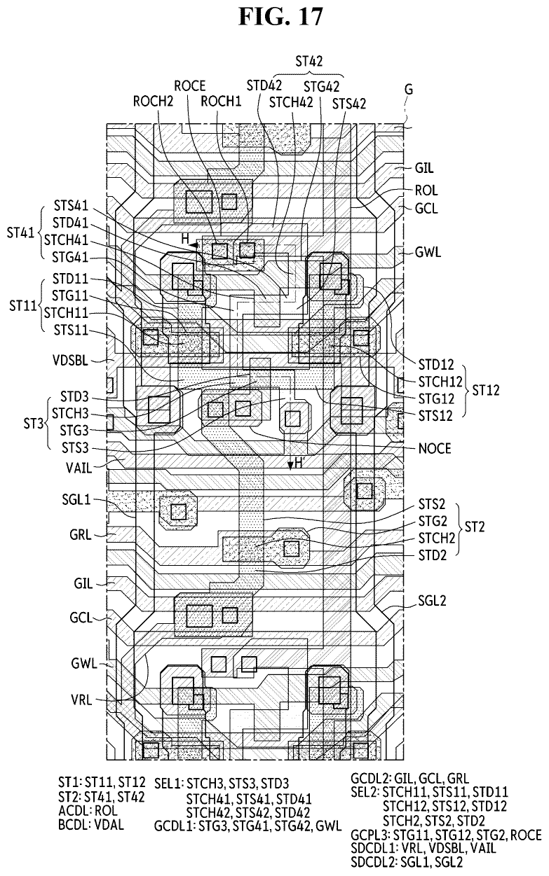

Referring to FIGS. 11 and 12, the circuit layer 120 (see FIG. 12) of the display device 100 according to one or more embodiments may include an additional conductive layer ACDL (see FIGS. 16 and 17) disposed on the substrate 110 (see FIG. 12), an additional buffer layer ABFL (see FIG. 12) covering the additional conductive layer ACDL, a light blocking conductive layer BCDL (see FIG. 11) disposed on the additional buffer layer ABFL, a buffer layer 121 (see FIG. 12) covering the light blocking conductive layer BCDL, and the first semiconductor layer SEL1 (see FIG. 11) disposed on the buffer layer 121.

According to one or more embodiments, the circuit layer 120 may include a first gate insulating layer 122 (see FIG. 12) covering the first semiconductor layer SEL1 and the buffer layer 121, a first gate conductive layer GCDL1 (see FIG. 11) disposed on the first gate insulating layer 122, a second gate insulating layer 123 (see FIG. 12) covering the first gate conductive layer GCDL1 and the first gate insulating layer 122, a second gate conductive layer GCDL2 (see FIG. 11) disposed on the second gate insulating layer 123, a first interlayer insulating layer 124 (see FIG. 12) covering the second gate conductive layer GCDL2 and the second gate insulating layer 123, a second semiconductor layer SEL2 (see FIG. 11) disposed on the first interlayer insulating layer 124, a third gate insulating layer 125 (see FIG. 12) covering the second semiconductor layer SEL2 and the first interlayer insulating layer 124, a third gate conductive layer GCDL3 (see FIG. 11) disposed on the third gate insulating layer 125, a second interlayer insulating layer 126 (see FIG. 12) covering the third gate conductive layer GCDL3 and the third gate insulating layer 125, a first source-drain conductive layer SDCDL1 (see FIG. 12) disposed on the second interlayer insulating layer 126, a first planarization layer 127 (see FIG. 12) covering the first source-drain conductive layer SDCDL1 and the second interlayer insulating layer 126, a second source-drain conductive layer SDCDL2 (see FIG. 12) disposed on the first planarization layer 127, a second planarization layer 128 (see FIG. 12) covering the second source-drain conductive layer SDCDL2 and the first planarization layer 127, a third source-drain conductive layer SDCDL3 (see FIG. 12) disposed on the second planarization layer 128, and a third planarization layer 129 (see FIG. 12) covering the third source-drain conductive layer SDCDL3 and the second planarization layer 128.

As illustrated in FIG. 11, the first transistor T1, the second transistor T2, the third transistor T3, the fourth transistor T4, the fifth transistor T5, the sixth transistor T6, the seventh transistor T7, and the eighth transistor T8 included in the light emitting pixel driver EPD (see FIG. 10) may include gate electrodes G1, G2, G3, G4, G5, G6, G7, and G8, channel portions CH1, CH2, CH3, CH4, CH5, CH6, CH7, and CH8 overlapping the gate electrodes G1, G2, G3, G4, G5, G6, G7, and G8, first electrode portions S1, S2, S3, S4, S5, S6, S7, and S8 connected to one sides of the channel portions CH1, CH2, CH3, CH4, CH5, CH6, CH7, and CH8, and second electrode portions D1, D2, D3, D4, D5, D6, D7, and D8 connected to the other sides of the channel portions CH1, CH2, CH3, CH4, CH5, CH6, CH7, and CH8, respectively.

The channel portions CH1, CH2, CH5, CH6, CH7, and CH8, the first electrode portions S1, S2, S5, S6, S7, and S8, and the second electrode portions D1, D2, D5, D6, D7, and D8 of the first transistor T1, the second transistor T2, the fifth transistor T5, the sixth transistor T6, the seventh transistor T7, and the eighth transistor T8 provided as P-type MOSFETs may be disposed in the first semiconductor layer SEL1.

The gate electrodes G1, G2, G5, G6, G7, and G8 of the first transistor T1, the second transistor T2, the fifth transistor T5, the sixth transistor T6, the seventh transistor T7, and the eighth transistor T8 may be disposed in the first gate conductive layer GCDL1.

The channel portion CH1 of the first transistor T1 may overlap the light blocking portion LBP disposed in the light blocking conductive layer BCDL.

The light blocking conductive layer BCDL may include a power auxiliary line VDAL that transmits the first power ELVDD (see FIG. 10).

The power auxiliary line VDAL may extend in the first direction DR1 to be connected to the light blocking portion LBP.

That is, the light blocking portion LBP may be maintained at the first power ELVDD through the power auxiliary line VDAL. In this way, a part of the channel portion CH1 of the first transistor T1 that is adjacent to the light blocking portion LBP is affected by the first power ELVDD, so that the variation in the threshold voltage characteristics of the first transistor T1 may be reduced.

The first electrode portion S1 of the first transistor T1 may be connected to the second electrode portion D2 of the second transistor T2, the second electrode portion D5 of the fifth transistor T5, and the second electrode portion D8 of the eighth transistor T8.

The second electrode portion D1 of the first transistor T1 may be connected to the first electrode portion S6 of the sixth transistor T6.

The second electrode portion D6 of the sixth transistor T6 may be connected to the second electrode portion D7 of the seventh transistor T7.

The first gate conductive layer GCDL1 may include the scan write line GWL, the bias control line GBL, and the gate initialization voltage line VIL.

The scan write line GWL may extend in the first direction DR1 and may overlap the channel portion CH2 of the second transistor T2.

A portion of the scan write line GWL overlapping the channel portion CH2 of the second transistor T2 may be the gate electrode G2 of the second transistor T2.

The bias control line GBL may extend in the first direction DR1 and may overlap the channel portion CH7 of the seventh transistor T7.

A portion of the bias control line GBL overlapping the channel portion CH7 of the seventh transistor T7 may be the gate electrode G7 of the seventh transistor T7.

The gate initialization voltage line VIL may extend in the first direction DR1.

The second gate conductive layer GCDL2 may include the capacitor electrode CPE that overlaps the gate electrode G1 of the first transistor T1.

The second gate conductive layer GCDL2 may further include the gate control line GCL that transmits the gate control signal GC (see FIG. 10) and the scan initialization line GIL that transmits the scan initialization signal GI (see FIG. 10).

Each of the gate control line GCL and the scan initialization line GIL may extend in the first direction DR1.

The channel portions CH3 and CH4, the first electrode portions S3 and S4, and the second electrode portions D3 and D4 of the third transistor T3 and the fourth transistor T4, which are provided as N-type MOSFETs, may be disposed in the second semiconductor layer SEL2.

The gate electrode G3 of the third transistor T3 and the gate electrode G4 of the fourth transistor T4 may be disposed in the third gate conductive layer GCDL3.

The channel portion CH3 of the third transistor T3 may overlap the gate control line GCL and the gate electrode G3 of the third transistor T3.

The gate electrode G3 of the third transistor T3 may be electrically connected to the gate control line GCL.

The first electrode portion S3 of the third transistor T3 may be disposed adjacent to the second electrode portion D1 (see FIG. 12) of the first transistor T1.

The second electrode portion D3 of the third transistor T3 may be connected to the second electrode portion D4 of the fourth transistor T4.

The channel portion CH4 of the fourth transistor T4 may overlap the scan initialization line GIL and the gate electrode G4 of the fourth transistor T4.

The gate electrode G4 of the fourth transistor T4 may be electrically connected to the scan initialization line GIL.

The first electrode portion S4 of the fourth transistor T4 may be disposed adjacent to the first initialization voltage line VIL.

The third gate conductive layer GCDL3 may further include the emission control line ECL that transmits the emission control signal EC (see FIG. 10) and the bias voltage line VBL that transmits the bias voltage VBS (see FIG. 10).

The emission control line ECL may cross the channel portion CH5 of the fifth transistor T5 and the channel portion CH6 of the sixth transistor T6, and may be electrically connected to the gate electrode G5 of the fifth transistor T5 and the gate electrode G6 of the sixth transistor T6.

The bias voltage line VBL may be disposed adjacent to the first electrode portion S8 of the eighth transistor T8.

As illustrated in FIG. 12, the channel portion CH1, the first electrode portion S1, and the second electrode portion D1 of the first transistor T1 may be disposed in the first semiconductor layer SEL1 (see FIG. 11) on the buffer layer 121.

The first electrode portion S1 of the first transistor T1 may be connected to one side of the channel portion CH1 of the first transistor T1, and the second electrode portion D1 of the first transistor T1 may be connected to the other side of the channel portion CH1 of the first transistor T1.

The gate electrode G1 of the first transistor T1 may be disposed in the first gate conductive layer GCDL1 (see FIG. 11) on the first gate insulating layer 122, and may overlap the channel portion CH1 of the first transistor T1.

The channel portion CH1 of the first transistor T1 may overlap the light blocking portion LBP disposed in the light blocking conductive layer BCDL (see FIG. 11) on the additional buffer layer ABFL.

The channel portion CH2, the first electrode portion S2, and the second electrode portion D2 of the second transistor T2 may be disposed in the first semiconductor layer SEL1 (see FIG. 11) on the buffer layer 121.

The gate electrode G2 of the second transistor T2 may be disposed in the first gate conductive layer GCDL1 (see FIG. 11) on the first gate insulating layer 122, and may overlap the channel portion CH2 of the second transistor T2.

The first electrode portion S2 of the second transistor T2 may be electrically connected to the data line DL through a first data connection electrode DCE1 and a second data connection electrode DCE2.

The first data connection electrode DCE1 may be disposed the first source-drain conductive layer SDCDL1 on the second interlayer insulating layer 126, and may be electrically connected to the first electrode portion S2 of the second transistor T2 through a first data connection hole DCH1 penetrating the second interlayer insulating layer 126, the third gate insulating layer 125, the first interlayer insulating layer 124, the second gate insulating layer 123, and the first gate insulating layer 122.

The second data connection electrode DCE2 may be disposed in the second source-drain conductive layer SDCDL2 on the first planarization layer 127, and may be electrically connected to the first data connection electrode DCE1 through a second data connection hole DCH2 penetrating the first planarization layer 127.

The data line DL may be disposed in the third source-drain conductive layer SDCDL3 on the second planarization layer 128, and may be electrically connected to the second data connection electrode DCE2 through a third data connection hole DCH3 penetrating the second planarization layer 128.

The channel portion CH6, the first electrode portion S6, and the second electrode portion D6 of the sixth transistor T6 may be disposed in the first semiconductor layer SEL1 (see FIG. 11) on the buffer layer 121.

The gate electrode G6 of the sixth transistor T6 may be disposed in the first gate conductive layer GCDL1 (see FIG. 11) on the first gate insulating layer 122, and may overlap the channel portion CH6 of the sixth transistor T6.

The second electrode portion D6 of the sixth transistor T6 may be electrically connected to the anode electrode 131 through a first anode connection electrode ANCE1, a second anode connection electrode ANCE2, and a third anode connection electrode ANCE3.

The first anode connection electrode ANCE1 may be disposed on the second interlayer insulating layer 126, and may be electrically connected to the second electrode portion D6 of the sixth transistor T6 through a first anode connection hole ANCH1 penetrating the second interlayer insulating layer 126, the third gate insulating layer 125, the first interlayer insulating layer 124, the second gate insulating layer 123, and the first gate insulating layer 122.

The second anode connection electrode ANCE2 may be disposed on the first planarization layer 127, and may be electrically connected to the first anode connection electrode ANCE1 through a second anode connection hole ANCH2 penetrating the first planarization layer 127.

The third anode connection electrode ANCE3 may be disposed on the second planarization layer 128, and may be electrically connected to the second anode connection electrode ANCE2 through a third anode connection hole ANCH3 penetrating the second planarization layer 128.

The anode electrode 131 may be disposed on a third planarization layer 129, and may be electrically connected to the third anode connection electrode ANCE3 through a fourth anode connection hole ANCH4 penetrating the third planarization layer 129.

The second gate conductive layer GCDL2 on the second gate insulating layer 123 may include the capacitor electrode CPE overlapping the gate electrode G1 of the first transistor T1.

The pixel capacitor PC1 (see FIG. 10) may be provided by an overlapping area between the capacitor electrode CPE and the gate electrode G1 of the first transistor T1.

The channel portion CH4, the first electrode portion S4, and the second electrode portion D4 of the fourth transistor T4 may be disposed in the second semiconductor layer SEL2 (see FIG. 11) on the first interlayer insulating layer 124.

The gate electrode G4 of the fourth transistor T4 may be disposed in the third gate conductive layer GCDL3 (see FIG. 11) on the third gate insulating layer 125, and may be electrically connected to the scan initialization line GIL.

The channel portion CH4 of the fourth transistor T4 may overlap the scan initialization line GIL and the gate electrode G4 of the fourth transistor T4. That is, one surface of the channel portion CH4 of the fourth transistor T4 may face the gate electrode G4 of the fourth transistor T4, and the other surface of the channel portion CH4 of the fourth transistor T4 may face the scan initialization line GIL.

The first source-drain conductive layer SDCDL1 on the second interlayer insulating layer 126 may include an initialization voltage connection electrode VICNE and a gate connection electrode GCNE.

The first electrode portion S4 of the fourth transistor T4 may be electrically connected to the initialization voltage connection electrode VICNE through an initialization voltage connection hole VICH penetrating the second interlayer insulating layer 126 and the third gate insulating layer 125.

The second electrode portion D4 of the fourth transistor T4 may be electrically connected to the gate electrode G1 of the first transistor T1 through a gate connection electrode GCNE on the second interlayer insulating layer 126.

The gate connection electrode GCNE may be electrically connected to the second electrode portion D4 of the fourth transistor T4 through a first gate connection hole GCH1 penetrating the second interlayer insulating layer 126 and the third gate insulating layer 125.

The gate connection electrode GCNE may be electrically connected to the gate electrode G1 of the first transistor T1 through a second gate connection hole GCH2 penetrating the second interlayer insulating layer 126, the third gate insulating layer 125, the first interlayer insulating layer 124, and the second gate insulating layer 123.

In one or more embodiments, the third transistor T3 is an N-type MOSFET similarly to the fourth transistor T4, and the fifth transistor T5, the seventh transistor T7, and the eighth transistor T8 are P-type MOSFETs similarly to the first transistor T1, the second transistor T2, and the sixth transistor T6, so that the redundant descriptions will be omitted below.

Each of the light emitting elements LE may include a structure in which a light emitting layer 133 of an organic light emitting material is interposed between an anode electrode 131 and a cathode electrode 134 facing each other.

Each of the light emitting elements LE may be an organic light emitting diode (OLED) including a light emitting layer made of an organic light emitting material. Alternatively, the light emitting element LE may be an inorganic light emitting element including a light emitting layer made of an inorganic semiconductor material. Alternatively, the light emitting element LE may be a quantum dot light emitting element including a light emitting layer made of a quantum dot material. Alternatively, the light emitting element LE may be a micro light emitting diode.

According to one or more embodiments, the element layer 130 may include the anode electrodes 131 disposed in the emission areas EA, a pixel defining layer 132 disposed between the emission areas EA and covering the edges of the anode electrodes 131, light emitting layers 133 disposed on the anode electrodes 131 of the emission areas EA, and the cathode electrode 134 disposed on the light emitting layers 133 and the pixel defining layer 132.

Alternatively, each of the light emitting elements LE may further include a first common layer disposed between the anode electrode 131 and the light emitting layer 133, and a second common layer disposed between the light emitting layer 133 and the cathode electrode 134.

The anode electrodes 131 of the emission areas EA may be electrically connected to the light emitting pixel drivers EPD of the circuit layer 120, respectively. The anode electrodes 131 may be referred to as pixel electrodes.

The pixel defining layer 132 may include an organic insulating material.

The light emitting layers 133 may be disposed on the anode electrodes 131 of the emission areas EA. The light emitting layers 133 may be formed of an organic light emitting material that converts electron-hole pairs into light.

The cathode electrode 134 may be disposed on the pixel defining layer 132 and the light emitting layers 133. That is, the cathode electrode 134 may be disposed entirely in the display area DA. The cathode electrode 134 may be referred to as a common electrode.

Further, according to one or more embodiments, the element layer 130 may include the light emitting elements LE disposed in the emission areas EA, and the light sensing elements OPD (see FIG. 10) disposed in the light sensing areas ODA.

Similarly to the light emitting elements LE, each of the light sensing elements OPD (see FIG. 10) may include a structure in which a photoelectric conversion layer made of a photoelectric conversion material is interposed between an anode electrode and a cathode electrode.

Therefore, the element layer 130 may further include anode electrodes disposed in the light sensing areas ODA (see FIG. 7), and a photoelectric conversion layer disposed on the anode and the cathode electrodes of the light sensing areas ODA (see FIG. 7).

Further, the pixel defining layer 132 may be disposed between the emission areas EA and the light sensing areas ODA, and may further cover the edges of the anode electrodes of the light sensing areas ODA (see FIG. 7).

The cathode electrode 134 may be disposed on the photoelectric conversion layer.

The encapsulation layer 140 may be disposed on the circuit layer 120 and cover the element layer 130.

The encapsulation layer 140 may include a first encapsulation layer disposed on the element layer 130 and containing an inorganic insulating material, a second encapsulation layer covering the element layer 130 and containing an organic insulating material, and a third encapsulation layer covering the second encapsulation layer and containing an inorganic insulating material.

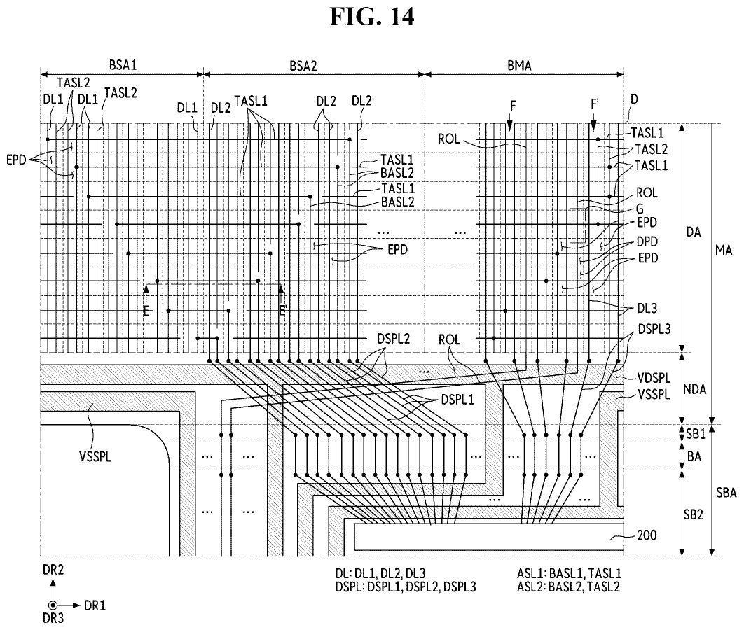

In one or more embodiments, the circuit layer 120 of the display device 100 according to one or more embodiments may further include first auxiliary lines ASL1 (see FIG. 14) and second auxiliary lines ASL2 (see FIG. 14) disposed in the display area DA. Due to the first auxiliary lines ASL1 and the second auxiliary lines ASL2, the width of the non-display area NDA may be reduced, and the voltage level of the second power source ELVSS (see FIG. 10) may be maintained relatively evenly in the entire display area DA.

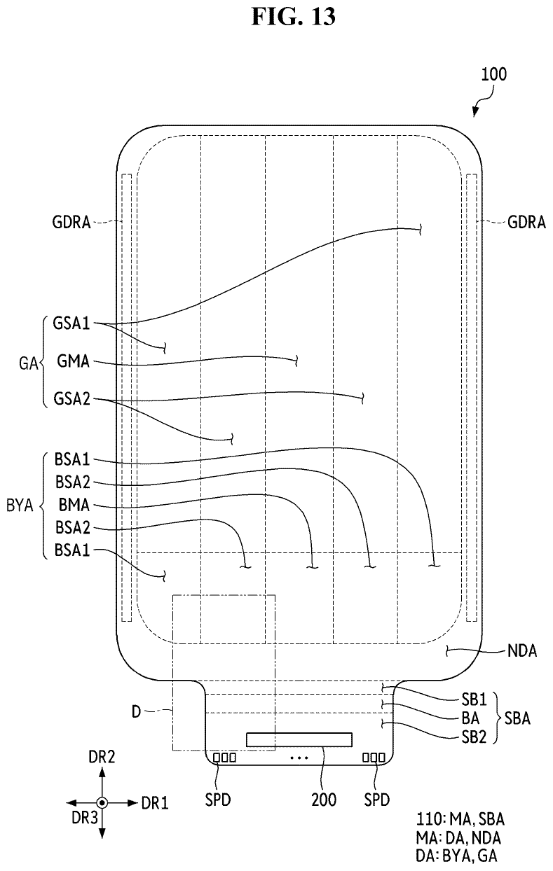

FIG. 13 is a schematic diagram illustrating the substrate of FIG. 4 according to one or more embodiments.

As shown in FIG. 13, the substrate 110 (e.g., see FIG. 12) of the display device 100 according to one or more embodiments may include the main region MA corresponding to the display surface, and the sub-region SBA protruding from one side of the main region MA.

The main region MA may include the display area DA disposed at most of the center, and the non-display area NDA disposed at the periphery to surround the display area DA.

The display area DA may include a bypass area BYA disposed on one side adjacent to the sub-region SBA, and a general area GA disposed in the remaining area excluding the bypass area BYA.

The bypass area BYA may include a bypass middle area BMA disposed at the center in the first direction DR1, a first bypass side area BSA1 parallel to the bypass middle area BMA in the first direction DR1 and in contact with the non-display area NDA, and a second bypass side area BSA2 disposed between the bypass middle area BMA and the first bypass side area BSA1.

The first bypass side area BSA1 may be disposed adjacent to the bent corner of the substrate 110 as compared to the bypass middle area BMA and the second bypass side area BSA2.

The first bypass side area BSA1 and the second bypass side area BSA2 may be disposed between the bypass middle area BMA and the non-display area NDA on both sides of the bypass middle area BMA in the first direction DR1.

The general area GA may include a general middle area GMA connected to the bypass middle area BMA of the bypass area BYA in the second direction DR2, a first general side area GSA1 connected to the first bypass side area BSA1 of the bypass area BYA in the second direction DR2, and a second general side area GSA2 connected to the second bypass side area BSA2 of the bypass area BYA in the second direction DR2.

The non-display area NDA may include a gate driving circuit area GDRA where the gate driving circuit 101 (see FIG. 9) is disposed.

The gate driving circuit area GDRA may face one side of the display area DA extending in the second direction DR2 in the non-display area NDA.

The gate driving circuit 101 (see FIG. 9) of the gate driving circuit area GDRA may sequentially transmit gate signals to the gate lines GL (see FIG. 9).

The gate lines GL (see FIG. 9) may include the scan write line GWL (see FIG. 10) that transmits the scan write signal GW (see FIG. 10), the scan initialization line GIL (see FIG. 10) that transmits the scan initialization signal GI (see FIG. 10), the gate control line GCL (see FIG. 10) that transmits the gate control signal GC (see FIG. 10), the bias control line GBL (see FIG. 10) that transmits the bias control signal GB (see FIG. 10), the emission control line ECL (see FIG. 10) that transmits the emission control signal EC (see FIG. 10), and the reset control line GRL that transmits the reset control signal GR (see FIG. 10).

The sub-region SBA may include the bending area BA that is transformed into a bent shape, the first sub-region SB1 disposed between one side of the bending area BA and the main region MA, and the second sub-region SB2 connected to the other side of the bending area BA.

When the bending area BA is transformed into a bent shape, the second sub-region SB2 is disposed below the substrate 110 and overlaps the main region MA.

The display driving circuit 200 may be disposed in the second sub-region SB2.

The signal pads SPD may be arranged at one edge of the second sub-region SB2, and may be bonded to the display circuit board 300 (see FIG. 4).

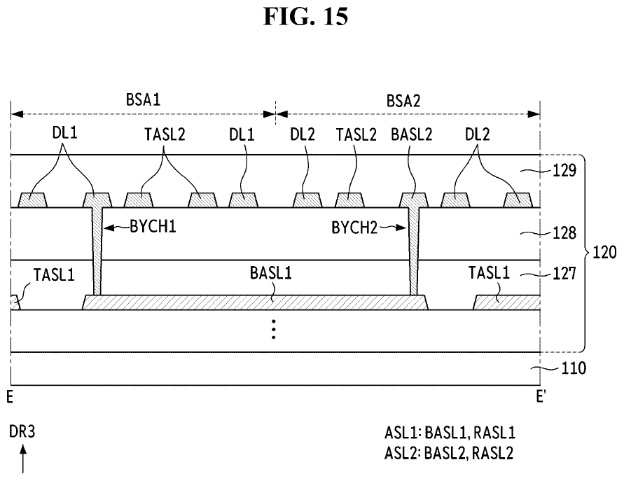

FIG. 14 is a schematic diagram showing a part D of FIG. 13 according to one or more embodiments. FIG. 15 is a cross-sectional view taken along the line E-E′ of FIG. 14.

Referring to FIG. 14, the circuit layer 120 (see FIG. 4) of the display device 100 according to one or more embodiments may include the light emitting pixel drivers EPD arranged side by side along the first direction DR1 and the second direction DR2, and the data lines DL that extend in the second direction DR2 and transmit the data signal Vdata to the light emitting pixel drivers EPD.

The light emitting pixel drivers EPD may be respectively electrically connected to the light emitting elements LE (see FIG. 12) of the element layer 130 (see FIG. 4).

The data lines DL may include the first data lines DL1 disposed in the first bypass side area BSA1 and the second data lines DL2 disposed in the second bypass side area BSA2. That is, the first data lines DL1 may be disposed closer to the non-display area NDA in the first direction DR1 than the second data lines DL2.

According to one or more embodiments, the circuit layer 120 may further include the first auxiliary lines ASL1 disposed in the display area DA and extending in the first direction DR1, and the second auxiliary lines ASL2 disposed in the display area DA, extending in the second direction DR2, and adjacent to the data lines DL.

According to one or more embodiments, the circuit layer 120 may further include data supply lines DSPL disposed in the non-display area NDA and electrically connected to the display driving circuit 200 and the data lines DL.

The data supply lines DSPL may extend to the bypass middle area BMA and the second bypass side area BSA2.

The data supply lines DSPL may include first data supply lines DSPL1 that transmit the data signal of the first data lines DL1, and second data supply lines DSPL2 that transmit the data signal of the second data lines DL2.

The first auxiliary lines ASL1 may include first bypass auxiliary lines BASL1 that are electrically connected to the first data lines DL1 adjacent to the non-display area NDA in the first direction DR1 from among the data lines DL (e.g., see FIG. 15).

The second auxiliary lines ASL2 may include second bypass auxiliary lines BASL2 that are electrically connected to the first bypass auxiliary lines BASL1 and adjacent to the second data lines DL2 (e.g., see FIG. 15).

The first data supply lines DSPL1 may extend to the second bypass auxiliary lines BASL2 of the second bypass side area BSA2, and may be electrically connected to the first data lines DL1 through the second bypass auxiliary lines BASL2 and the first bypass auxiliary lines BASL1.

On the other hand, the second data supply lines DSPL2 may extend to the second bypass side area BSA2, and may be electrically connected directly to the second data lines DL2.

The data lines DL may further include a third data line DL3 disposed in the bypass middle area BMA. In addition, the data supply lines DSPL may further include a third data supply line DSPL3 that transmits the data signal of the third data line DL3.

The third data supply line DSPL3 may extend to the bypass middle area BMA, and may be electrically connected directly to the third data line DL3.

The first auxiliary lines ASL1 may further include first transmission auxiliary lines TASL1 in order to reduce visibility of the first bypass auxiliary lines BASL1.

The first bypass auxiliary lines BASL1 may be disposed in the first bypass side area BSA1 and the second bypass side area BSA2 of the bypass area BYA.

The first transmission auxiliary lines TASL1 may be disposed between one sides of the first bypass auxiliary lines BASL1 and the non-display area NDA, between the other sides of the first bypass auxiliary lines BASL1 and the bypass middle area BMA, and in the bypass middle area BMA, and the general area GA.

The second auxiliary lines ASL2 may further include second transmission auxiliary lines TASL2 in order to reduce visibility of the second bypass auxiliary lines BASL2.

The second bypass auxiliary lines BASL2 may be disposed in the second bypass side area BSA2 of the bypass area BYA.

The second transmission auxiliary lines TASL2 may be disposed between one sides of the second bypass auxiliary lines BASL2 and the second general side area GSA2, and in the first bypass side area BSA1, the bypass middle area BMA, and the general area GA.

At least some of the first transmission auxiliary lines TASL1 and at least some of the second transmission auxiliary lines TASL2 may transmit the second power ELVSS (see FIG. 10).

In this way, because the first data supply lines DSPL1 extend not to the first data lines DL1 of the first bypass side area BSA1 but to the second bypass auxiliary lines BASL2 of the second bypass side area BSA2, the extension length of the first data supply lines DSPL1 may be shortened. Accordingly, the width of the area required for arranging the data supply lines DSPL may be reduced.

Further, the data supply lines DSPL are not disposed in some of the non-display area NDA that are adjacent to the bent corners of the substrate 110.

Therefore, the width of the non-display area NDA may be further reduced by the first auxiliary line ASL1 and the second auxiliary line ASL2.

According to one or more embodiments, the circuit layer 120 may further include a first power supply line VDSPL and a second power supply line VSSPL that transmit the first power ELVDD (see FIG. 10) and the second power ELVSS (see FIG. 10), respectively.

The first power supply line VDSPL and the second power supply line VSSPL may be disposed in the non-display area NDA and may extend to the sub-region SBA.

According to one or more embodiments, each of the first power supply line VDSPL and the second power supply line VSSPL may be disposed in at least one of the first source-drain conductive layer SDCDL1 (see FIG. 12), the second source-drain conductive layer SDCDL2 (see FIG. 12), or the third source-drain conductive layer SDCDL3 (see FIG. 12).

At least some of the first transmission auxiliary lines TASL1 may be electrically connected to the second power supply line VSSPL.

At least some of the second transmission auxiliary lines TASL2 may be electrically connected to at least some of the first transmission auxiliary lines TASL1 and the second power supply line VSSPL.

Referring to FIG. 15, the data lines DL and the second auxiliary lines ASL2 may be disposed on an insulating layer (i.e., the first planarization layer 127 and the second planarization layer 128) covering the first auxiliary lines ASL1.

For example, the first auxiliary lines ASL1 may be disposed in the first source-drain conductive layer SDCDL1 (see FIG. 12) on a second interlayer insulating layer 126.

The data lines DL and the second auxiliary lines ASL2 may be disposed in the third source-drain conductive layer SDCDL3 (see FIG. 12) on the second planarization layer 128.

The first bypass auxiliary line BASL1 may be electrically connected to the first data line DL1 through a first bypass connection hole BYCH1, and may be electrically connected to the second bypass auxiliary line BASL2 through a second bypass connection hole BYCH2.

The first bypass connection hole BYCH1 and the second bypass connection hole BYCH2 may penetrate the first planarization layer 127 and the second planarization layer 128, respectively.

FIG. 16 is a cross-sectional view taken along the line F-F′ of FIG. 14.

As illustrated in FIGS. 14 and 16, the circuit layer 120 of the display device 100 according to one or more embodiments may include the read-out lines ROL electrically connected to the light sensing pixel drivers DPD (see FIG. 7) of the display sensing area DSA (see FIG. 5).

The read-out lines ROL may extend in the second direction DR2.

According to one or more embodiments, the read-out lines ROL may be disposed in the additional conductive layer ACDL on the substrate 110, and may be covered with the additional buffer layer ABFL.

Because the data lines DL are disposed in the third source-drain conductive layer SDCDL3 (see FIG. 12) on the second planarization layer 128, the separation distance between the read-out lines ROL and the data lines DL, which corresponds to the total thickness of the second planarization layer 128, the first planarization layer 127, the second interlayer insulating layer 126, the third gate insulating layer 125, the first interlayer insulating layer 124, the second gate insulating layer 123, the first gate insulating layer 122, the buffer layer 121, and the additional buffer layer ABFL, may be secured.

That is, even if the read-out lines ROL are adjacent to or overlap the data lines DL in the first direction DR1 and the second direction DR2, the separation distance between the read-out lines ROL and the data lines DL may be secured.

Accordingly, there is no need to secure the separation distance between the read-out lines ROL and the data lines DL in the first direction DR1 and the second direction DR2 in order to prevent distortion of the light sensing signal of the read-out line ROL, which may be suitable for improve the resolution of the display device 100.

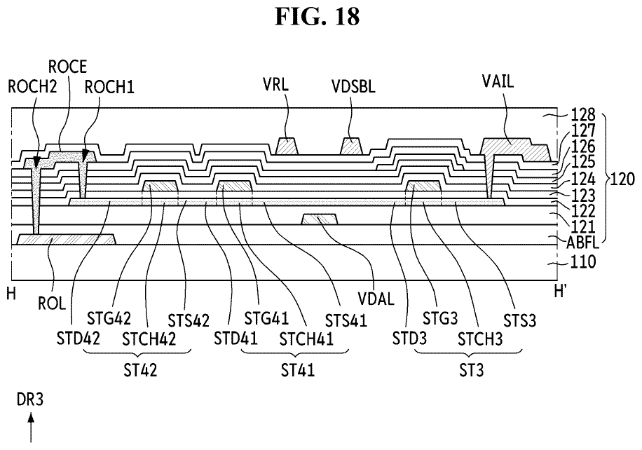

FIG. 17 is a plan view showing a part G of FIG. 14. FIG. 18 is a cross-sectional view taken along the line H-H′ of FIG. 17.

First, as illustrated in FIG. 10, each of the light sensing pixel drivers DPD in the circuit layer 120 of the display device 100 according to one or more embodiments may include at least one first sensing transistor ST1 electrically connected between at least one light sensing element OPD and the output node NOP, the second sensing transistor ST2 electrically connected between the reset voltage line VRL and the output node NOP, the third sensing transistor ST3 electrically connected to the second initialization voltage line VAIL and turned on according to the potential of the output node NOP, and the fourth sensing transistor ST4 electrically connected between the read-out line ROL and the third sensing transistor ST3.

At least one first sensing transistor ST1 may include the first sensing sub-transistor ST11 that is turned on in response to the first sensing gate signal SG1 of the first sensing gate line SGL1 and electrically connected between the output node NOP and the anode electrode of the first light sensing element OPD1, and the second sensing sub-transistor ST12 that is turned on in response to the second sensing gate signal SG2 of the second sensing gate line SGL2 and electrically connected between the output node NOP and the anode electrode of the second light sensing element OPD2.

The fourth sensing transistor ST4 may include a third sensing sub-transistor ST41 and a fourth sensing sub-transistor ST42 that are connected in series.

The first sensing transistor ST1 and the second sensing transistor ST2 may be provided as N-type MOSFETs, and the third sensing transistor ST3 and the fourth sensing transistor ST4 may be provided as P-type MOSFETs.

Referring to FIG. 17, at least one first sensing transistor ST11 and ST12, the second sensing transistor ST2, the third sensing transistor ST3 and the fourth sensing transistor ST41 and ST42 may include gate electrodes STG11, STG12, STG2, STG3, STG41, and STG42, channel portions STCH11, STCH12, STCH2, STCH3, STCH41, and STCH42 overlapping the gate electrodes STG11, STG12, STG2, STG3, STG41, and STG42, first electrode portions STS11, STS12, STS2, STS3, STS41, and STS42 connected to one sides of the channel portions STCH11, STCH12, STCH2, STCH3, STCH41, and STCH42, and second electrode portions STD11, STD12, STD2, STD3, STD41, and STD42 connected to the other sides of the channel portions STCH11, STCH12, STCH2, STCH3, STCH41, and STCH42, respectively.

As shown in FIGS. 17 and 18, the channel portions STCH3, STCH41, and STCH42, the first electrode portions STS3, STS41, and STS42, and the second electrode portions STD3, STD41, and STD42 of the third sensing transistor ST3 and the fourth sensing transistor ST41 and ST42, which are provided as P-type MOSFETs, may be disposed in the first semiconductor layer SEL1.

The gate electrodes STG3, STG41, and STG42 of the third sensing transistor ST3 and the fourth sensing transistor ST41 and ST42 may be disposed in the first gate conductive layer GCDL1.

The gate electrode STG3 of the third sensing transistor ST3 may be electrically connected to the second electrode portions STS11 and STS12 of at least one first sensing transistor ST11 and ST12 and the second electrode portion STS2 of the second sensing transistor ST2 through the output node connection electrode NOCE.

The gate electrode STG41 of the third sensing sub-transistor ST41 and the gate electrode STG42 of the fourth sensing sub-transistor ST42 may be parts of the scan write line GWL.

The first electrode portion STS3 of the third sensing transistor ST3 may be electrically connected to the second initialization voltage line VAIL.

The second initialization voltage line VAIL may be disposed in the first source-drain conductive layer SDCDL1.

The second electrode portion STD3 of the third sensing transistor ST3 may be connected to the first electrode portion STS41 of the third sensing sub-transistor ST41.

The second electrode portion STD41 of the third sensing sub-transistor ST41 may be connected to the first electrode portion STS42 of the fourth sensing sub-transistor ST42.

The second electrode portion STD42 of the fourth sensing sub-transistor ST42 may be electrically connected to the read-out line ROL through a read-out connection electrode ROCE.

According to one or more embodiments, the read-out line ROL may be disposed in the additional conductive layer ACDL on the substrate 110.

The read-out connection electrode ROCE may be disposed in the third gate conductive layer GCDL3 on the third gate insulating layer 125.

The read-out connection electrode ROCE may be electrically connected to the second electrode portion STD42 of the fourth sensing sub-transistor ST42 through a first read-out connection hole ROCH1, and may be electrically connected to the read-out line ROL through a second read-out connection hole ROCH2.

The first read-out connection hole ROCH1 may penetrate the third gate insulating layer 125, the first interlayer insulating layer 124, the second gate insulating layer 123, and the first gate insulating layer 122.

The second read-out connection hole ROCH2 may penetrate the third gate insulating layer 125, the first interlayer insulating layer 124, the second gate insulating layer 123, the first gate insulating layer 122, the buffer layer 121, and the additional buffer layer ABFL.

As illustrated in FIG. 17, the channel portions STCH11, STCH12, and STCH2, the first electrode portions STD11, STD12, and STD2, and the second electrode portions STS11, STS12, and STS2 of the first sensing sub-transistor ST11, the second sensing sub-transistor ST12, and the second sensing transistor ST2, which are provided as N-type MOSFETs, may be disposed in the second semiconductor layer SEL2.

The gate electrodes STG11, STG12, and STG2 of the first sensing sub-transistor ST11, the second sensing sub-transistor ST12, and the second sensing transistor ST2 may be disposed in the third gate conductive layer GCDL3.

The gate electrode STG11 of the first sensing sub-transistor ST11 may be electrically connected to the first sensing gate line SGL1.

The gate electrode STG12 of the second sensing sub-transistor ST12 may be electrically connected to the second sensing gate line SGL2.

Each of the first sensing gate line SGL1 and the second sensing gate line SGL2 may extend in the second direction DR2, and may be disposed in the second source-drain conductive layer SDCDL2.

The gate electrode STG2 of the second sensing transistor ST2 may be electrically connected to the reset control line GRL.

The reset control line GRL may be disposed in the second gate conductive layer GCDL2.

The first electrode portion STD11 of the first sensing sub-transistor ST11 may be electrically connected to the anode electrode of the first light sensing element OPD1 (see FIG. 10).

The first electrode portion STD12 of the second sensing sub-transistor ST12 may be electrically connected to the anode electrode of the second light sensing element OPD2 (see FIG. 10).

The second electrode portion STS11 of the first sensing sub-transistor ST11 and the second electrode portion STS12 of the second sensing sub-transistor ST12 may be connected to each other, connected to the second electrode portion STS2 of the second sensing transistor ST2, and electrically connected to the gate electrode STG3 of the third sensing transistor ST3 through the output node connection electrode NOCE.

The first electrode portion STD2 of the second sensing transistor ST2 may be electrically connected to the reset voltage line VRL.

The reset voltage line VRL may be disposed in the first source-drain conductive layer SDCDL1.

The first source-drain conductive layer SDCDL1 may further include a first power sub-line VDSBL that transmits the first power ELVDD (see FIG. 10).

As described above, according to one or more embodiments, the read-out line ROL is disposed in the additional conductive layer ACDL on the substrate 110, not in the same layer as the data line DL. Therefore, the separation distance between the read-out lines ROL and the data lines DL, which corresponds to the total thickness of the second planarization layer 128, the first planarization layer 127, the second interlayer insulating layer 126, the third gate insulating layer 125, the first interlayer insulating layer 124, the second gate insulating layer 123, the first gate insulating layer 122, the buffer layer 121, and the additional buffer layer ABFL, may be secured. Therefore, even if the read-out lines ROL are adjacent to or overlap the data lines DL in the first direction DR1 and the second direction DR2, the defect in which the light sensing signal transmitted through the read-out lines ROL are coupled with the data signal Vdata (see FIG. 10) of the data lines DL may be reduced.

Therefore, there is no need to secure the separation distance between the read-out lines ROL and the data lines DL in the first direction DR1 and the second direction DR2, which may be suitable for improve the resolution of the display device 100.

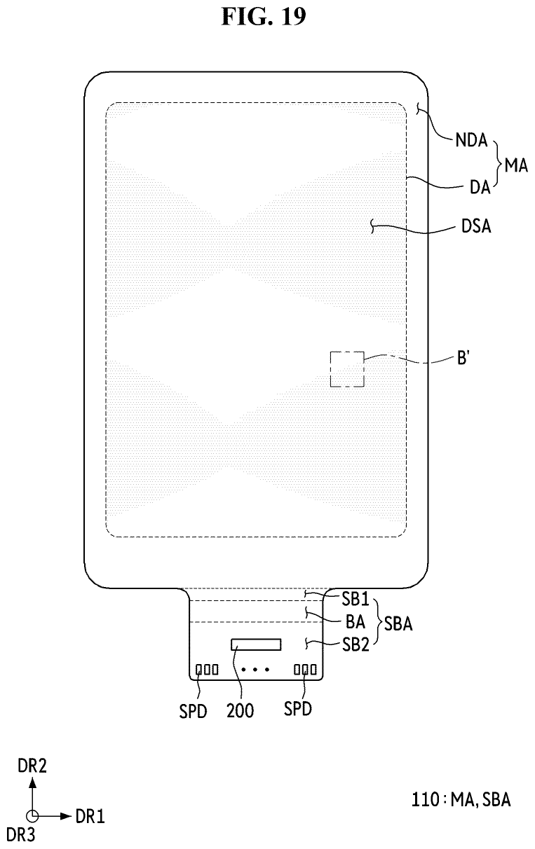

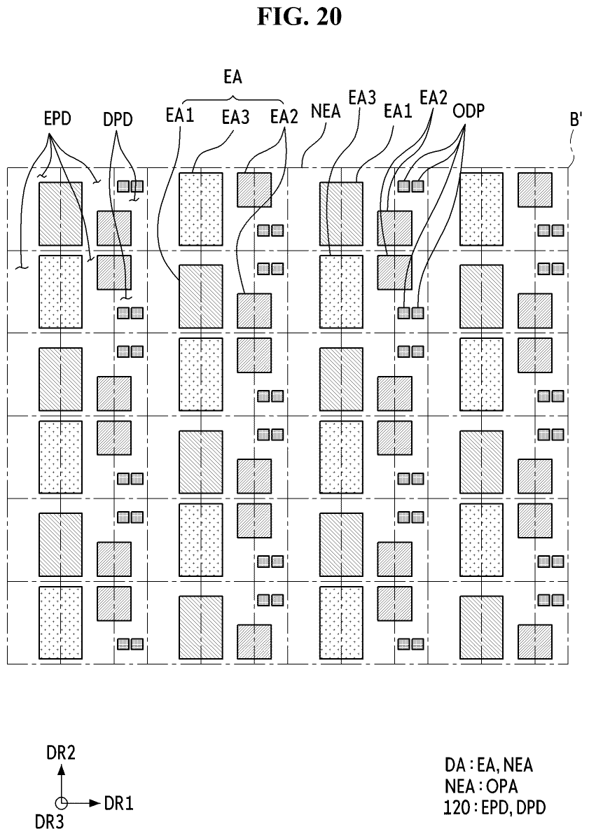

FIG. 19 is a schematic diagram illustrating the substrate of FIG. 4 according to one or more embodiments. FIG. 20 is a schematic diagram showing a part B′ of FIG. 19.

According to one or more embodiments, the display device 100 as illustrated in FIGS. 19 and 20 is substantially the same as the display device 100 of one embodiment illustrated in FIG. 3-18, except that the display sensing area DSA is disposed in the entire display area DA, not in a part of the display area DA, so that the redundant description will be omitted below.

According to one or more embodiments, because the read-out lines ROL (see FIGS. 17 and 18) are disposed in the additional conductive layer ACDL (see FIG. 17) on the substrate 110 (see FIG. 18), the separation distance between the read-out lines ROL and the data lines DL may be secured in the third direction DR3. Accordingly, even if the separation distance between the read-out lines ROL and the data lines DL is not secured in the first direction DR1 and the second direction DR2, distortion of the light sensing signal of the read-out line ROL due to coupling with the data signal Vdata (see FIG. 10) may be prevented.

That is, because the read-out lines ROL may be adjacent to or overlap the data lines DL in the first direction DR1 and the second direction DR2, the influence of the arrangement of the read-out lines ROL on the resolution may be reduced.

Therefore, according to one or more embodiments, the display sensing area DSA may be disposed in the entire display area DA.

In this way, the scanning function may be provided in the entire display area DA without considerably deteriorating the display quality, so that the convenience of the display device 100 and the electronic device 10 including the same may be improved.

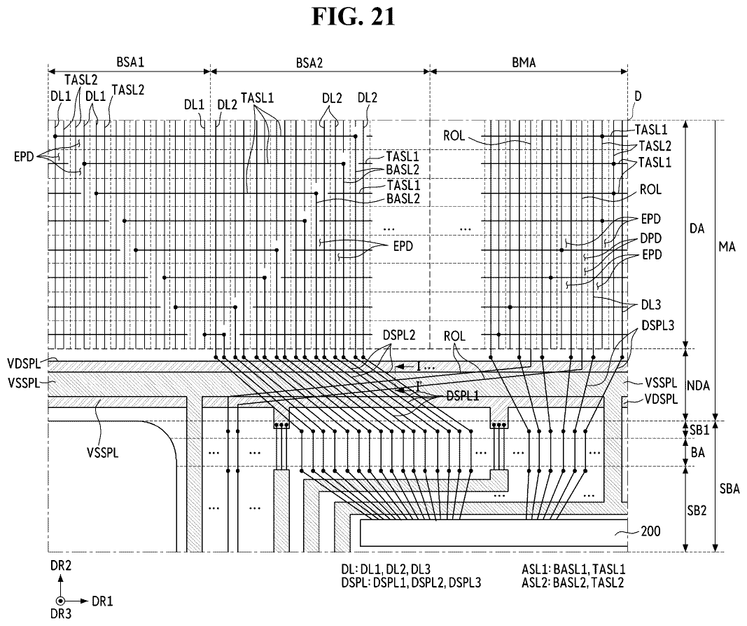

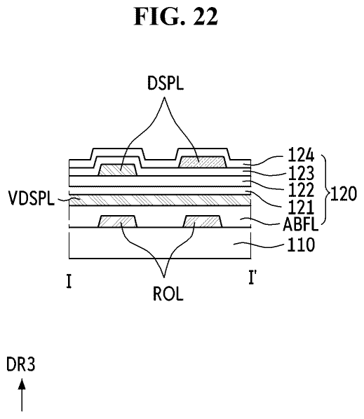

FIG. 21 is a schematic diagram showing a part D of FIG. 13 according to one or more embodiments. FIG. 22 is a cross-sectional view taken along the line I-I′ of FIG. 21.

The display device 100 according to one or more embodiments as illustrated in FIGS. 21 and 22 is substantially the same as the display device 100 according to one or more embodiments as illustrated in FIG. 3-18 and the display device 100 according to one or more embodiments as illustrated in FIGS. 19 and 20 except that the first power supply line VDSPL is disposed in the light blocking conductive layer BCDL, so that the redundant description will be omitted below.

According to one or more embodiments, each of the data supply lines DSPL may be disposed in at least one of the first gate conductive layer GCDL1 (see FIG. 11) on the first gate insulating layer 122 or the second gate conductive layer GCDL2 (see FIG. 11) on the second gate insulating layer 123.

The read-out lines ROL may be disposed in the additional conductive layer ACDL (see FIGS. 16 and 17) on the substrate 110, and may extend to the non-display area NDA.

Accordingly, in the non-display area NDA, the read-out lines ROL may cross or overlap the data supply lines DSPL.

According to one or more embodiments, the first power supply line VDSPL may be disposed in the light blocking conductive layer BCDL (see FIG. 11) on the additional buffer layer ABFL together with the power auxiliary line VDAL.

For example, the power auxiliary line VDAL may be connected to the first power supply line VDSPL.

Because the first power supply line VDSPL is disposed in the light blocking conductive layer BCDL (see FIG. 11), a part of the first power supply line VDSPL may overlap the read-out lines ROL and the data supply lines DSPL.

That is, a part of the first power supply line VDSPL may be interposed between the read-out lines ROL and the data supply lines DSPL.

In this way, the influence of the data signal Vdata (see FIG. 10) of the data supply lines DSPL on the light sensing signal of the read-out lines ROL may be reduced by the first power supply line VDSPL. Therefore, the deterioration of the precision of the scanning function due to the data signal Vdata (see FIG. 10) of the data supply lines DSPL may be reduced or prevented.

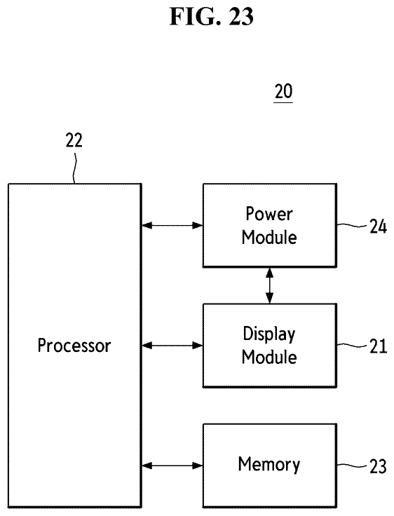

The display device 100 according to one or more embodiments as described above may be applied to various electronic devices 20 (see FIG. 23).

An electronic device 20 (see FIG. 23) according to one or more embodiments may include the display device 100 described above.

Additionally, the electronic device 20 (see FIG. 23) according to one or more embodiments may further include a module or device having other additional functions in addition to the display device 100.

FIG. 23 is a block diagram showing an electronic device according to one or more embodiments.

Referring to FIG. 23, the electronic device 20 according to one or more embodiments may include a display module 21, a processor 22, a memory 23, and a power module 24.

The processor 22 may include at least one of a central processing unit (CPU), an application processor (AP), a graphic processing unit (GPU), a communication processor (CP), an image signal processor (ISP), or a controller.

Data information required for the operation of the processor 22 or display module 21 may be stored in the memory 23. When the processor 22 executes an application stored in the memory 23, an image data signal and/or an input control signal may be transmitted to the display module 21, and the display module 21 may process the provided signal and may output image information through a display screen.

The power module 24 may include a power supply module, such as a power adapter or a battery device, and a power conversion module that converts power supplied by the power supply module to generate power required for the operation of the electronic device 20.

At least one of the respective components of the electronic device 20 described above may be included in the display device according to the embodiments described above. Additionally, some of the individual modules functionally included within one module may be included within the display device, and others may be provided separately from the display device. For example, the display device may include the display module 21, and the processor 22, the memory 23 and the power module 24 may be provided in the form of other devices within the electronic device 20 other than the display device.

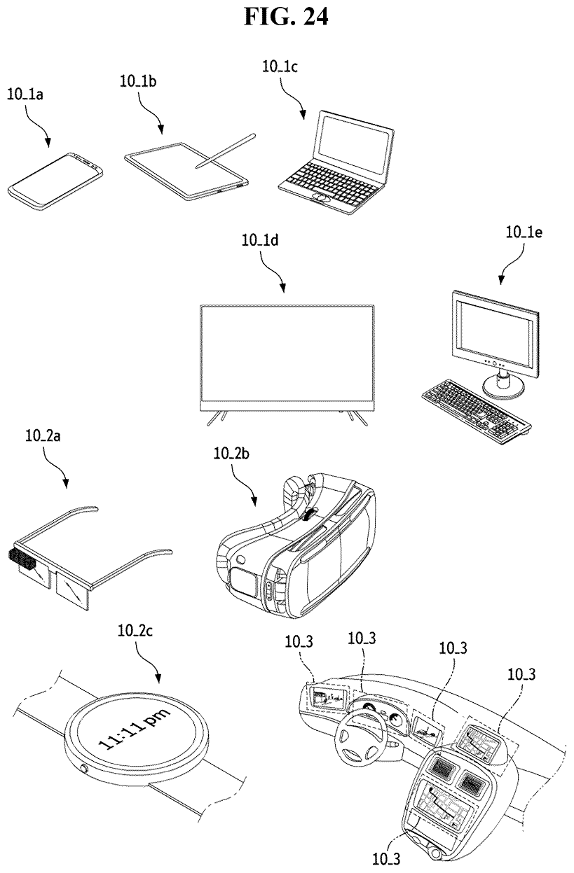

FIG. 24 is a schematic diagram of electronic devices according to one or more embodiments.

Referring to FIG. 24, the electronic devices 20 (see FIG. 23) according to one or more embodiments may include not only an image display electronic device such as a smartphone 10_1a, a tablet PC 10_1b, a laptop 10_1c, a TV 10_1d, and a desk monitor 10_1e, but also a wearable electronic device such as smart glasses 10_2a, a head mounted display 10_2b, and a smart watch 10_2c, and a vehicle electronic device 10_3 such as a dashboard of a vehicle, a center fascia, a center information display (CID) of the dashboard, and a room mirror display.

However, effects, aspects, and features of the present disclosure are not restricted to the one set forth herein. The above and other effects, aspects, and features of the present disclosure will become more apparent to one of daily skill in the art to which the present disclosure pertains by referencing the claims and their equivalents.

What is claimed is:

1. A display device comprising:
a substrate having a display area from which light is emitted, and a non-display area around the display area;
a circuit layer on the substrate; and
an element layer on the circuit layer,
wherein the display area includes emission areas arranged side by side and emitting light, and a non-emission area between the emission areas,
a display sensing area, which is at least a part of the display area, the display sensing area including light sensing areas arranged in the non-emission area,
wherein the element layer comprises light emitting elements in the emission areas, and light sensing elements in the light sensing areas, and
wherein the circuit layer comprises:
an additional conductive layer on the substrate;
an additional buffer layer covering the additional conductive layer;
a light blocking conductive layer on the additional buffer layer;
a buffer layer covering the light blocking conductive layer; and
a first semiconductor layer on the buffer layer.

2. The display device of claim 1, further comprising a scanning driving circuit configured to collect light sensing signals by the light sensing elements,
wherein the circuit layer further comprises:
light sensing pixel drivers electrically connected to the light sensing elements; and
read-out lines electrically connected between the light sensing pixel drivers and the scanning driving circuit,
wherein the read-out lines are in the light blocking conductive layer.

3. The display device of claim 2, wherein the circuit layer further comprises:
light emitting pixel drivers electrically connected to the light emitting elements; and
data lines electrically connected to the light emitting pixel drivers.

4. The display device of claim 3, wherein the circuit layer further comprises:
a first gate insulating layer covering the first semiconductor layer;
a first gate conductive layer on the first gate insulating layer;
a second gate insulating layer covering the first gate conductive layer;
a second gate conductive layer on the second gate insulating layer;
a first interlayer insulating layer covering the second gate conductive layer;
a second semiconductor layer on the first interlayer insulating layer;
a third gate insulating layer covering the second semiconductor layer;
a third gate conductive layer on the third gate insulating layer;
a second interlayer insulating layer covering the third gate conductive layer;
a first source-drain conductive layer on the second interlayer insulating layer;
a first planarization layer covering the first source-drain conductive layer;
a second source-drain conductive layer on the first planarization layer;
a second planarization layer covering the second source-drain conductive layer;
a third source-drain conductive layer on the second planarization layer; and
a third planarization layer covering the third source-drain conductive layer,
wherein the data lines are in the third source-drain conductive layer.

5. The display device of claim 4, wherein the display sensing area is in the entire display area.

6. The display device of claim 4, wherein each of the light sensing pixel drivers comprises:
at least one first sensing transistor electrically connected between an output node and at least one of the light sensing elements;
a second sensing transistor electrically connected between the output node and a reset voltage line configured to transmit a reset voltage;
a third sensing transistor electrically connected to a sensing initialization voltage line configured to transmit a sensing initialization voltage, the third sensing transistor being turned on according to a potential of the output node; and
a fourth sensing transistor electrically connected between a read-out line from among the read-out lines and the third sensing transistor.

7. The display device of claim 6, wherein each of the first sensing transistor, the second sensing transistor, the third sensing transistor, and the fourth sensing transistor comprises a gate electrode, a channel portion overlapping the gate electrode, a first electrode portion connected to one side of the channel portion, and a second electrode portion connected to the other side of the channel portion,
the channel portion, the first electrode portion, and the second electrode portion of each of the third sensing transistor and the fourth sensing transistor are in the first semiconductor layer,
the gate electrode of each of the third sensing transistor and the fourth sensing transistor is in the first gate conductive layer,
the first electrode portion of the third sensing transistor is electrically connected to the sensing initialization voltage line,
the first electrode portion of the fourth sensing transistor is connected between the first electrode portion of the third sensing transistor and one side of the channel portion of the fourth sensing transistor, and
the second electrode portion of the fourth sensing transistor is electrically connected to the read-out line.

8. The display device of claim 7, wherein the circuit layer further comprises a read-out connection electrode in the third gate conductive layer and electrically connected to the read-out line and the second electrode portion of the fourth sensing transistor.

9. The display device of claim 7, wherein the channel portion, the first electrode portion, and the second electrode portion of each of the at least one first sensing transistor and the second sensing transistor are in the second semiconductor layer, and
the gate electrode of each of the at least one first sensing transistor and the second sensing transistor is in the third gate conductive layer.

10. The display device of claim 4, further comprising a display driving circuit configured to supply data signals of the data lines,
wherein the circuit layer further comprises:
data supply lines in the non-display area and electrically connected between each of the data lines and the display driving circuit; and
a first power supply line in the non-display area and configured to transmit a first power,
wherein the read-out lines extend to the non-display area,
each of the data supply lines is in one of the first gate conductive layer and the second gate conductive layer,
the first power supply line is in the light blocking conductive layer, and
a part of the first power supply line overlaps the data supply lines and the read-out lines.

11. The display device of claim 10, wherein in the display area, a bypass area comprises a bypass middle area, a first bypass side area parallel to the bypass middle area in a first direction and in contact with the non-display area, and a second bypass side area between the bypass middle area and the first bypass side area,
wherein the data supply lines extend to the bypass middle area and the second bypass side area,
wherein the data lines comprise a first data line in the first bypass side area, and a second data line in the second bypass side area, and
wherein the circuit layer further comprises:
first auxiliary lines in the display area and extending in the first direction; and
second auxiliary lines in the display area and extending in a second direction intersecting the first direction and adjacent to the data lines,
wherein the first auxiliary lines comprise a first bypass auxiliary line in at least one of the first source-drain conductive layer or the second source-drain conductive layer and electrically connected to the first data line,
wherein the second auxiliary lines comprise a second bypass auxiliary line in the third source-drain conductive layer, adjacent to the second data line and electrically connected to the first bypass auxiliary line,
wherein the data supply lines comprise a first data supply line transmitting a data signal of the first data line, and a second data supply line transmitting a data signal of the second data line,
wherein the first data supply line is electrically connected to the first data line through the second bypass auxiliary line and the first bypass auxiliary line, and
wherein the second data supply line is electrically connected directly to the second data line.

12. The display device of claim 10, wherein each of the light emitting pixel drivers comprises:
a first transistor electrically connected between a first node and a second node;
a second transistor electrically connected between the first node and one of the data lines;
a pixel capacitor electrically connected between a first power line configured to transmit the first power and a gate electrode of the first transistor;
a third transistor electrically connected between the second node and the gate electrode of the first transistor;
a fourth transistor electrically connected between a first initialization voltage line configured to transmit a first initialization voltage and the gate electrode of the first transistor;
a fifth transistor electrically connected between the first power line and the first node;
a sixth transistor electrically connected between a third node and the second node;
a seventh transistor electrically connected between the third node and a second initialization voltage line configured to transmit a second initialization voltage; and
an eighth transistor electrically connected between the first node and a bias voltage line configured to transmit a bias voltage.

13. The display device of claim 12, wherein each of the first transistor, the second transistor, the third transistor, the fourth transistor, the fifth transistor, the sixth transistor, the seventh transistor and the eighth transistor comprises a gate electrode, a channel portion overlapping the gate electrode, a first electrode portion connected to one side of the channel portion, and a second electrode portion connected to the other side of the channel portion,
wherein the channel portion, the first electrode portion, and the second electrode portion of each of the first transistor, the second transistor, the fifth transistor, the sixth transistor, the seventh transistor, and the eighth transistor are in the first semiconductor layer,
wherein the gate electrode of each of the first transistor, the second transistor, the fifth transistor, the sixth transistor, the seventh transistor, and the eighth transistor is in the first gate conductive layer,
wherein the channel portion, the first electrode portion, and the second electrode portion of each of the third transistor and the fourth transistor are in the second semiconductor layer,
wherein the gate electrode of each of the third transistor and the fourth transistor is in the third gate conductive layer, and
wherein the light blocking conductive layer comprises a light blocking portion overlapping the channel portion of the first transistor.

14. The display device of claim 13, wherein the circuit layer further comprises a power auxiliary line in the light blocking conductive layer, connected to the light blocking portion, and configured to transmit the first power.

15. An electronic device comprising:
a display device configured to display an image;
a memory configured to store an application;
a processor configured to execute the application and transmit an image data signal and an input control signal to the display device; and
a power supply module configured to supply power to the display device,
wherein the display device comprises:
a substrate having a display area from which light is emitted, and a non-display area around the display area;
a circuit layer on the substrate; and
an element layer on the circuit layer,
wherein the display area comprises emission areas arranged side by side and configured to emit light, and a non-emission area between the emission areas,
wherein a display sensing area, which is at least a part of the display area, includes light sensing areas arranged in the non-emission area,
wherein the element layer comprises light emitting elements in the emission areas, and light sensing elements in the light sensing areas, and
wherein the circuit layer comprises:
an additional conductive layer on the substrate;
an additional buffer layer covering the additional conductive layer;
a light blocking conductive layer on the additional buffer layer;
a buffer layer covering the light blocking conductive layer;
a first semiconductor layer on the buffer layer;
a first gate insulating layer covering the first semiconductor layer;
a first gate conductive layer on the first gate insulating layer;
a second gate insulating layer covering the first gate conductive layer;
a second gate conductive layer on the second gate insulating layer;
a first interlayer insulating layer covering the second gate conductive layer;
a second semiconductor layer on the first interlayer insulating layer;
a third gate insulating layer covering the second semiconductor layer;
a third gate conductive layer on the third gate insulating layer;
a second interlayer insulating layer covering the third gate conductive layer;
a first source-drain conductive layer on the second interlayer insulating layer;
a first planarization layer covering the first source-drain conductive layer;
a second source-drain conductive layer on the first planarization layer;
a second planarization layer covering the second source-drain conductive layer;
a third source-drain conductive layer on the second planarization layer; and
a third planarization layer covering the third source-drain conductive layer.

16. The electronic device of claim 15, further comprising:
a display driving circuit configured to supply data signals; and
a scanning driving circuit configured to collect light sensing signals of the light sensing elements,
wherein the circuit layer further comprises:
light sensing pixel drivers electrically connected to the light sensing elements;
read-out lines electrically connected between the light sensing pixel drivers and the scanning driving circuit;
light emitting pixel drivers electrically connected to the light emitting elements; and
data lines electrically connected between the light emitting pixel drivers and the display driving circuit,
wherein the read-out lines are in the light blocking conductive layer, and
wherein the data lines are in the third source-drain conductive layer.

17. The electronic device of claim 16, wherein the display sensing area is in the entire display area.

18. The electronic device of claim 16, wherein each of the light sensing pixel drivers comprises:
at least one first sensing transistor electrically connected between an output node and at least one of the light sensing elements;
a second sensing transistor electrically connected between the output node and a reset voltage line configured to transmit a reset voltage;
a third sensing transistor electrically connected to a sensing initialization voltage line configured to transmit a sensing initialization voltage, the third sensing transistor being turned on according to a potential of the output node; and
a fourth sensing transistor electrically connected between a read-out line from among the read-out lines and the third sensing transistor,
wherein each of the first sensing transistor, the second sensing transistor, the third sensing transistor, and the fourth sensing transistor comprises a gate electrode, a channel portion overlapping the gate electrode, a first electrode portion connected to one side of the channel portion, and a second electrode portion connected to the other side of the channel portion,
wherein the channel portion, the first electrode portion, and the second electrode portion of each of the third sensing transistor and the fourth sensing transistor are in the first semiconductor layer,
wherein the second electrode portion of the fourth sensing transistor is electrically connected to the read-out line through a read-out connection electrode, and
wherein the read-out connection electrode is in the third gate conductive layer.

19. The electronic device of claim 16, further comprising a display driving circuit supplying data signals of the data lines,
wherein the circuit layer further comprises:
data supply lines in the non-display area and electrically connected between each of the data lines and the display driving circuit; and
a first power supply line in the non-display area and configured to transmit a first power,
wherein the read-out lines extend to the non-display area,
wherein each of the data supply lines is in one of the first gate conductive layer and the second gate conductive layer,
wherein the first power supply line is in the light blocking conductive layer, and
wherein a part of the first power supply line overlaps the data supply lines and the read-out lines.

20. The electronic device of claim 16, wherein each of the light emitting pixel drivers comprises:
a first transistor electrically connected between a first node and a second node;
a second transistor electrically connected between the first node and one of the data lines;
a pixel capacitor electrically connected between a first power line configured to transmit a first power and a gate electrode of the first transistor;
a third transistor electrically connected between the second node and the gate electrode of the first transistor;
a fourth transistor electrically connected between a first initialization voltage line configured to transmit a first initialization voltage and the gate electrode of the first transistor;
a fifth transistor electrically connected between the first power line and the first node;
a sixth transistor electrically connected between a third node and the second node;
a seventh transistor electrically connected between the third node and a second initialization voltage line configured to transmit a second initialization voltage; and
an eighth transistor electrically connected between the first node and a bias voltage line configured to transmit a bias voltage,
wherein each of the first transistor, the second transistor, the third transistor, the fourth transistor, the fifth transistor, the sixth transistor, the seventh transistor, and the eighth transistor comprises a gate electrode, a channel portion overlapping the gate electrode, a first electrode portion connected to one side of the channel portion, and a second electrode portion connected to the other side of the channel portion,
wherein the channel portion, the first electrode portion, and the second electrode portion of each of the first transistor, the second transistor, the fifth transistor, the sixth transistor, the seventh transistor, and the eighth transistor are in the first semiconductor layer, and
wherein the channel portion, the first electrode portion, and the second electrode portion of each of the third transistor and the fourth transistor are in the second semiconductor layer, and
wherein the light blocking conductive layer comprises:
a light blocking portion overlapping the channel portion of the first transistor; and
a power auxiliary line connected to the light blocking portion and configured to transmit the first power.
